(19) United States
(12) Patent Application Publication
(10) Pub. No.: US 2026/0268150 A1
(43) Pub. Date: Sep. 10, 2026

(54) METHOD AND SYSTEM FOR DATA AUGMENTATION FOR LEARNING OF TABULAR DATA

(71) Applicant: LG MANAGEMENT DEVELOPMENT INSTITUTE CO., LTD., Seoul (KR)

(72) Inventors: Moon Jung EO, Seoul (KR); Kyung Eun LEE, Seoul (KR); Hye Seung CHO, Seoul (KR); Dong Min KIM, Seoul (KR); Ye Seul SIM, Seoul (KR); Woo Hyung LIM, Seoul (KR)

(21) Appl. No.: 19/674,128

(22) Filed: May 12, 2026

Related U.S. Application Data
(63) Continuation of application No. PCT/KR2025/014995, filed on Sep. 24, 2025.

(30) Foreign Application Priority Data
Sep. 25, 2024 (KR) 10-2024-0129772
Aug. 1, 2025 (KR) 10-2025-0105857

(51) Int. Cl. G06N 3/0895; G06N 3/0455

(52) U.S. Cl. CPC G06N 3/0895; G06N 3/0455

(57) ABSTRACT

A method and system for data augmentation for learning of tabular data and, more specifically, a method and system for representation-level data augmentation for improving performance of self-supervised learning (SSL) in tabular data.

### CROSS REFERENCE TO RELATED APPLICATIONS

This application is a Bypass Continuation of International Patent Application No. PCT/KR2025/014995, filed on September 24, 2025 that claims priority and the benefit of Korean Patent Application 10-2024-0129772, filed on September 25, 2024, and Korean Patent Application 10-2025-0105857, filed on August 1, 2025, each of which is hereby incorporated by reference for all purposes as if fully set forth herein.

### BACKGROUND

### FIELD

Embodiments of the invention relate generally to a method and system for data augmentation for learning of tabular data, and more particularly, to a method and system for representation-level data augmentation for improving performance of self-supervised learning (SSL) in tabular data.

### Discussion of the Background

Tabular data is composed of rows and columns, and is used in various fields, such as finance, medical, manufacturing, healthcare, marketing, and research. Despite such universality, deep learning research has, compared to a computer vision field or a natural language processing field, relatively paid less attention to tabular data.

Recently, self-supervised learning (SSL) is receiving attention as a promising pre-training method for tabular data. Through self-supervised learning, a model may extract meaningful feature and pattern from data without labels, and may utilize the meaningful feature and pattern in various downstream tasks. Such self-supervised learning, in many cases, generally depends on contrastive learning, and this is a method of exposing various transformations of input data to the model through data augmentation. This method supports learning a robust and generalizable representation by allowing a model to maintain invariance to a specific conversion (or transformation) while maintaining important information.

In this regard, applying self-supervised learning to tabular data is challenging because of the difficulty involved in designing effective data augmentation. An image or a text has a clear structure, thereby being relatively easy to generate augmentation (for example, image cropping or rotation, manipulation of a semantic structure of a text, and the like). In contrast, tabular data is heterogeneous and lacks a clear structure. That is, tabular data lacks inherent positional information or a spatial relationship, and, in particular, a heterogeneous mixture of data types, an arbitrary column order, and a complex inter-feature correlation further complicate this problem.

Despite a lack of a relational structure inherent in tabular data, most conventional studies have focused on defining augmentation at an input level. For example, a method of modifying a selected feature or randomly removing a selected feature may correspond thereto. These augmentation methods are simple to implement, but there is a possibility of damaging an important pattern or generating unrealistic data. As a result, input-level augmentation may degrade performance of self-supervised learning (SSL) in a tabular domain.

Accordingly, embodiments of the invention provide a method which overcomes limitations of conventional data augmentation and a learning method of the related art, and enable an artificial intelligence model to effectively learn also in tabular data.

The above information disclosed in this Background section is only for understanding of the background of the inventive concepts, and, therefore, it may contain information that does not constitute prior art.

### SUMMARY

A method and system for data augmentation for learning of tabular data according to embodiments of the invention enable an artificial intelligence model to well understand tabular data.

More specifically, the method and system for data augmentation for learning of tabular data according to embodiments of the invention enable an artificial intelligence model to learn an information-rich representation for tabular data.

Additional features of the inventive concepts will be set forth in the description which follows, and in part will be apparent from the description, or may be learned by practice of the inventive concepts.

According to embodiments of the invention, a computerized data augmentation method for learning of tabular data includes: inputting table data to a first encoder; obtaining, as an output of the first encoder, a first embedding vector corresponding to the table data; extracting, based on a preset extraction criterion, a specific parameter from the first encoder from which the first embedding vector is output; updating a second encoder, based on the specific parameter extracted according to the preset extraction criterion; inputting the table data to the updated the second encoder; obtaining, from the second encoder, an augmented second embedding vector corresponding to the table data; training a learning target model by using the first embedding vector and the second embedding vector.

The computerized data augmentation method may further include: inputting the specific parameter extracted from the first encoder to a preset specific module; and performing decomposition for the specific parameter by using a preset decomposition method of the specific module.

The specific module may decompose the specific parameter into at least one among a first singular vector matrix including first singular vectors, a second singular vector matrix including second singular vectors, and a diagonal matrix including singular values corresponding to the first singular vectors and the second singular vectors, respectively, and, in the updating of the first encoder, the second encoder may be updated by using an output of the specific module for the specific parameter.

The computerized data augmentation method may further include: specifying at least one singular value satisfying a preset criterion among the singular values; and generating a parameter to be used for updating the second encoder based on the specified singular value, and the parameter may correspond to an output of the specific module for the specific parameter, and may be used for updating the second encoder.

The specific module may specify a singular value specified according to the preset criterion among the singular values, and specify at least one among a first singular vector and a second singular vector corresponding to the specified singular value, and may generate the parameter based on at least one among the specified singular value, the specified first singular vector, and the specified second singular vector.

In the updating of the second encoder, the second may be updated by using the parameter output from the specific module.

The updating of the at second encoder may be inputting the parameter to the second encoder and setting a parameter of the at second encoder to the parameter output from the specific module, and the updated second encoder may be configured to generate an augmented second embedding vector corresponding to table data, based on the set parameter.

The updating of the second encoder may be updating the second encoder by using an output of the specific module, in order to generate the augmented second embedding vector for the first embedding vector obtained from the second encoder.

The computerized data augmentation method may further include: applying a preset normalization technique to at least one among the first encoder and the second encoder.

When the preset normalization technique is applied to at least one among the first encoder and the second encoder, stochastic variability may be provided to at least one among the first embedding vector corresponding to the table data obtained from the at least one encoder and the second embedding vector corresponding to the table data obtained from the second encoder.

For training of the learning target model, the computerized data augmentation method may further include: defining a first loss function and a second loss function, respectively, by using at least one among the first embedding vector and the second embedding vector.

The computerized data augmentation method may further include: inputting the first embedding vector and the second embedding vector to a projection head, respectively; and obtaining, from the projection head, a first projection vector corresponding to the first embedding vector and a second projection vector corresponding to the second embedding vector, and the first loss function may be defined by using the first projection vector corresponding to the first embedding vector and the second projection vector corresponding to the second embedding vector.

The first loss function may be defined to be trained in a direction of maximizing similarity between the first embedding vector and the second embedding vector.

The computerized data augmentation method may further include: inputting the first embedding vector to a first decoder; and obtaining, from the at least one decoder, a reconstructed output value by reconstructing the first embedding vector to correspond to the table data, and the second loss function may be defined by using the table data and the reconstructed output value.

The second loss function may be defined to learn a relationship between the table data and the reconstructed output value.

The computerized data augmentation method may further include: defining a final loss function by using the first loss function and the second loss function, and the learning target artificial intelligence model may be trained by using the final loss function.

The computerized data augmentation method may further include: performing binning for the table data; obtaining a plurality of binned table data as a result of performing the binning for the table data; and training the learning target model by using the plurality of binned table data.

Based on the plurality of binned table data being obtained, the computerized data augmentation method may include: inputting the plurality of binned table data to a first encoder; obtaining, as an output of the first encoder, a plurality of embedding vectors corresponding to the plurality of binned table data, respectively; extracting, based on the preset extraction criterion, a specific parameter from the first encoder from which the plurality of embedding vectors is output; updating a second encoder based on the specific parameter extracted according to the preset extraction criterion; inputting the plurality of binned table data to the updated second encoder; obtaining, from the second encoder, an augmented plurality of embedding vectors corresponding to the plurality of binned table data, respectively; and training the learning target model by using the plurality of embedding vectors obtained from the first encoder and the augmented plurality of embedding vectors obtained from the second encoder.

According to yet another embodiment of the invention, a data augmentation system for learning of tabular data, includes a memory configured to store executable instructions; and one or more processors configured to perform operations by executing one or more instructions,. The data augmentation system may: input table data to a first encoder; obtain, as an output of the first encoder, a first embedding vector corresponding to the table data; extract, based on a preset extraction criterion, a specific parameter from the first encoder from which the first embedding vector is output; update a second encoder based on the specific parameter extracted according to the preset extraction criterion; input the table data to the updated second encoder; obtain, from the second encoder, an augmented second embedding vector corresponding to the table data; and train a learning target model by using the first embedding vector and the second embedding vector.

According to yet another embodiment of the invention, a program executed by one or more processes in an electronic device, and storable in a transitory computer-readable recording medium, includes instructions for performing: inputting table data to a first encoder; obtaining, as an output of the first encoder, a first embedding vector corresponding to the table data; extracting, based on a preset extraction criterion, a specific parameter from the first encoder from which the first embedding vector is output; updating a second encoder based on the specific parameter extracted according to the preset extraction criterion; inputting the table data to the updated second encoder; obtaining, from the second encoder, an augmented second embedding vector corresponding to the table data; and training a learning target model by using the first embedding vector and the second embedding vector.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a conceptual diagram for describing a data augmentation system for learning of tabular data according to embodiments of the invention.

FIG. 2 is a flowchart for describing a data augmentation method for learning of tabular data according to embodiments of the invention.

FIG. 3A, FIG. 3B, FIG. 4A, and FIG. 4B are conceptual diagrams for describing the data augmentation method for learning of tabular data according to embodiments of the invention.

FIG. 5, FIG. 6, FIG. 7, FIG. 8, and FIG. 9 are equations and algorithms related to the data augmentation method for learning of tabular data according to embodiments of the invention.

FIG. 10 and FIG. 11 are tables illustrating performance of the data augmentation method according to embodiments of the invention and one embodiment of learning results of an artificial intelligence model trained by using a learning method according to the embodiments of the invention.

FIG. 12A, FIG. 12B, and FIG. 12C are conceptual diagrams for describing a method of training a model by performing binning for table data according to one embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, and/or aspects, etc. (hereinafter individually or collectively referred to as “elements”), of the various embodiments may be otherwise combined, separated, interchanged, and/or rearranged without departing from the inventive concepts.

When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

In the present application, it should be understood that terms "including", "having", and the like are intended to designate the existence of characteristics (or features), numbers, steps, operations, constituent elements, and components (or parts) described in the specification or a combination thereof, and do not exclude a possibility of the existence or addition of one or more other characteristics (or features), numbers, steps, operations, constituent elements, and components (or parts), or a combination thereof in advance.

Embodiments of the invention relate to a method and system for data augmentation for learning of tabular data that enables an artificial intelligence model to well understand tabular data. More specifically, embodiments of the invention relate to a method and a system for data augmentation for learning of tabular data such that an artificial intelligence model may learn an information-rich representation for tabular data.

In particular, embodiments of the invention may perform augmentation in an embedding space of a model (or an encoder) in order to maximize an effect of self-supervised learning (SSL) in tabular data (or a table, table data, table-form data, table-type data, and the like). More specifically, embodiments of the invention may perform augmentation in the embedding space by using a preset decomposition method (for example, singular value decomposition (SVD), truncated (or reduced) singular value decomposition (SVD), and the like) in order to learn an information-rich representation for table data. In this case, embodiments of the invention may effectively reflect characteristics of table data by applying a method of maintaining important information (or core information) included in table data while performing augmentation in the embedding space based on the preset decomposition method. Embodiments of the invention performs augmentation in a manner of modifying a weight matrix of a specific layer of the encoder, and, by applying the preset decomposition method in an augmentation process, may secure diversity of a representation while maintaining important information of table data. In one embodiment, a layer included in the model (or the encoder) according to the present invention may include at least one among a fully connected layer (dense layer) of an MLP (multi-layer perceptron) based encoder or a transformer-based encoder. In the present specification, a term of a layer may also be named as “a layer”, “a hierarchy”, or “a block”, and the like.

Here, the embedding space may mean a space after embedding input data through the encoder. Unlike an input space, the embedding space may be understood as a space including more structured and meaningful information. The embedding space is a multi-dimensional space in which an embedding converted (or generated) by the encoder exists, and a semantic and/or structural relationship between data may be reflected in the embedding space. That is, the embedding space is a space in which embedding vectors generated by an artificial intelligence model (or the encoder) are distributed (or located), and may also be understood as a vector space in which representations learned by the model (or the encoder) exist. For example, in the embedding space, each vector means one data sample, and, in contrastive learning, learning may be performed based on similarity (for example, cosine similarity, a distance, and the like) between samples in the embedding space. In the present specification, a term of the embedding space may be used interchangeably with “a representation space”, “a latent space”, “a latent representation space”, “a feature space”, “a hidden space”, “a vector space”, “an internal representation space”, and the like. Also, in the present specification, a term of an embedding vector may be used interchangeably with “a representation”, “an embedding representation”, “a latent representation”, “a feature representation”, “a hidden representation”, “an embedding”, “a vector”, “a latent vector”, “a feature vector”, “a hidden vector”, “an intermediate representation”, and the like.

In embodiments of the invention, performing augmentation in the embedding space of an artificial intelligence model may mean performing augmentation with respect to an embedding vector generated from the encoder or a parameter (or a parameter matrix, a weight, a weight matrix, and the like) of the encoder in which the embedding vector is generated. This may mean applying a modification to an embedding vector or a parameter generated by the encoder during learning, instead of directly modifying input data (for example, table data). For example, in embodiments of the invention, it is possible to update (or adjust, modify, change, and the like) a parameter of a final layer of the encoder generating an embedding vector, and to generate a variety of augmented embedding vectors for input data by using the updated encoder. That is, it may be understood as imparting diversity to a structure itself of the encoder forming the embedding space (for example, the encoder to which SVD is applied).

Accordingly, the method and the system for data augmentation for learning of tabular data according to embodiments of the invention may also be named as “representation-space augmentation for tabular data (RaTab) method and system”.

Embodiments of the invention may be usefully utilized in various situations. More specifically, the method and system for data augmentation for learning of tabular data according to embodiments of the invention may be applied to various industries and services, and may be usefully utilized. For example, in manufacturing industry, major decision making such as process optimization, quality management, equipment maintenance, and production prediction is made based on tabular data composed of sensor data, equipment logs, process variables, and the like. Embodiments of the invention may be applied to manufacturing industry utilizing massive tabular data generated in such manufacturing processes and inspection, and may be usefully utilized. However, a field in which embodiments of the invention are utilized is not necessarily limited only to the above-described fields, and it is natural that embodiments of the invention may be applied to and utilized in various fields (for example, a medical field, a financial field, a scientific field, an urban analysis, and the like) in addition to the described fields.

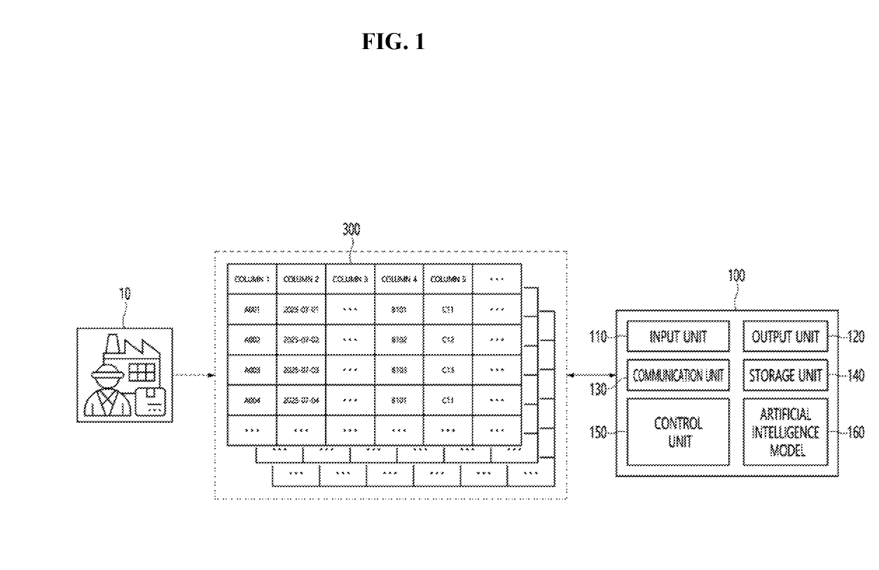

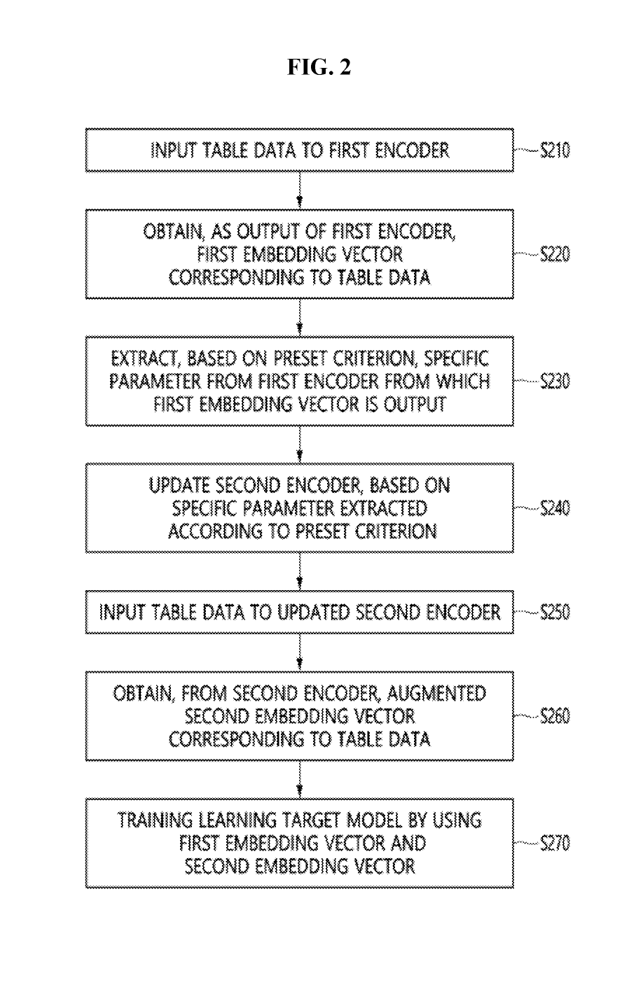

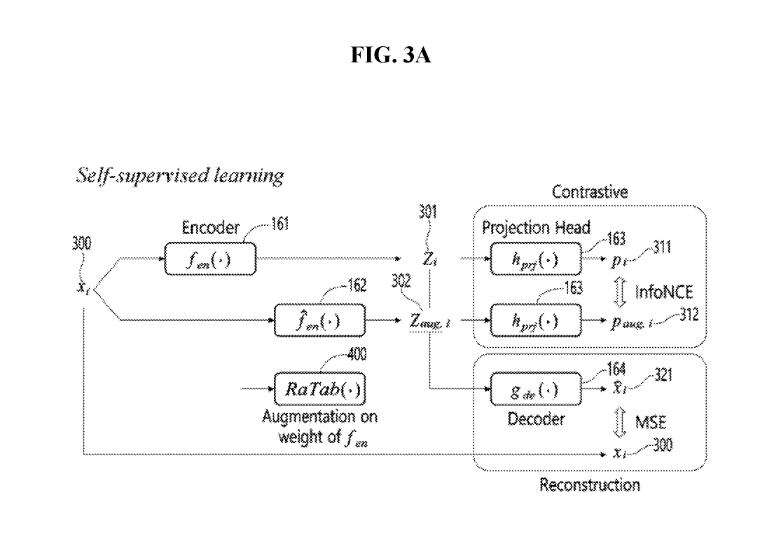

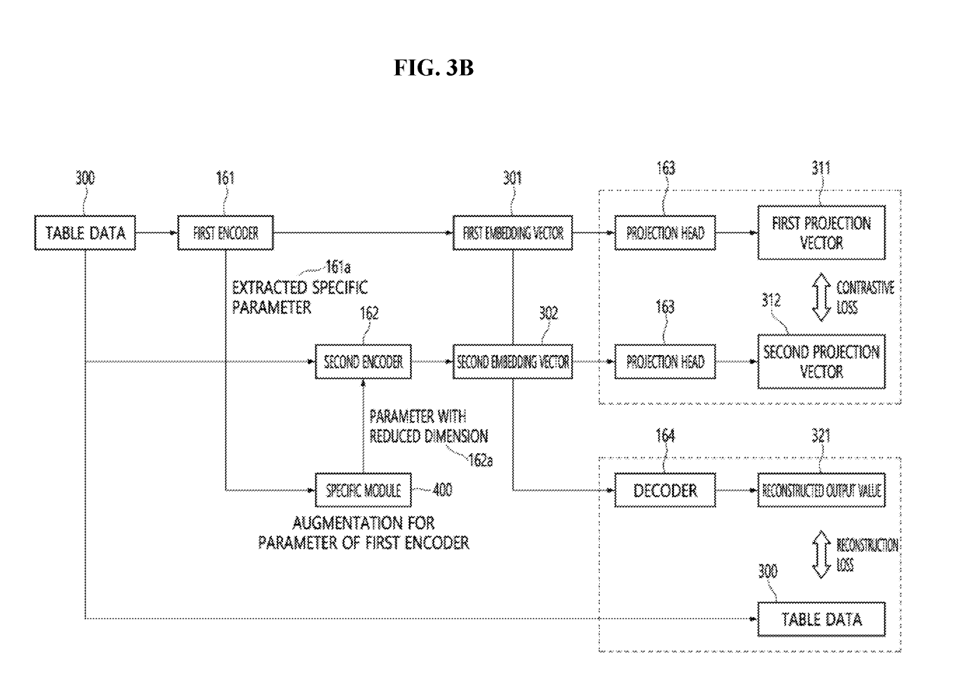

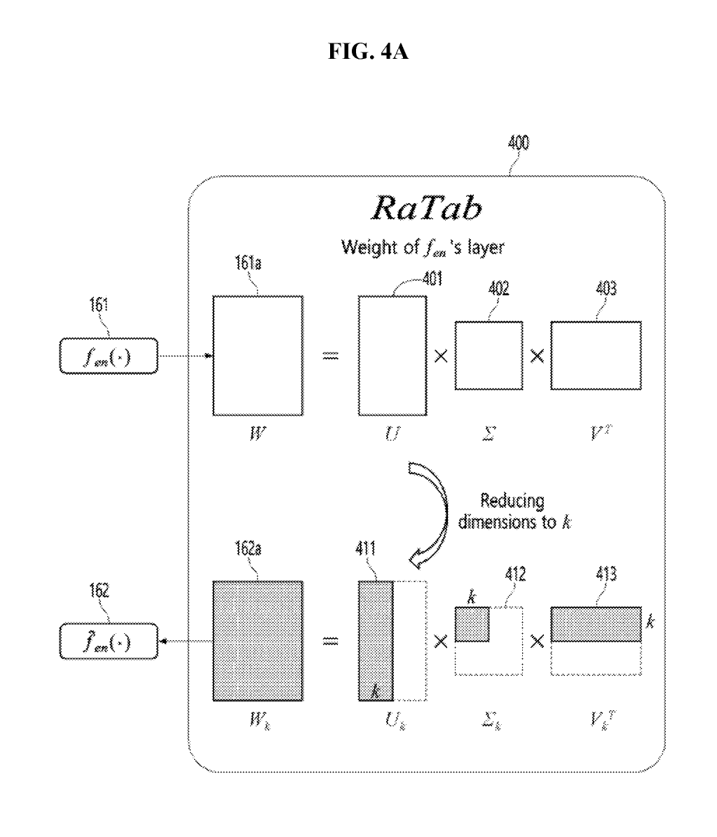

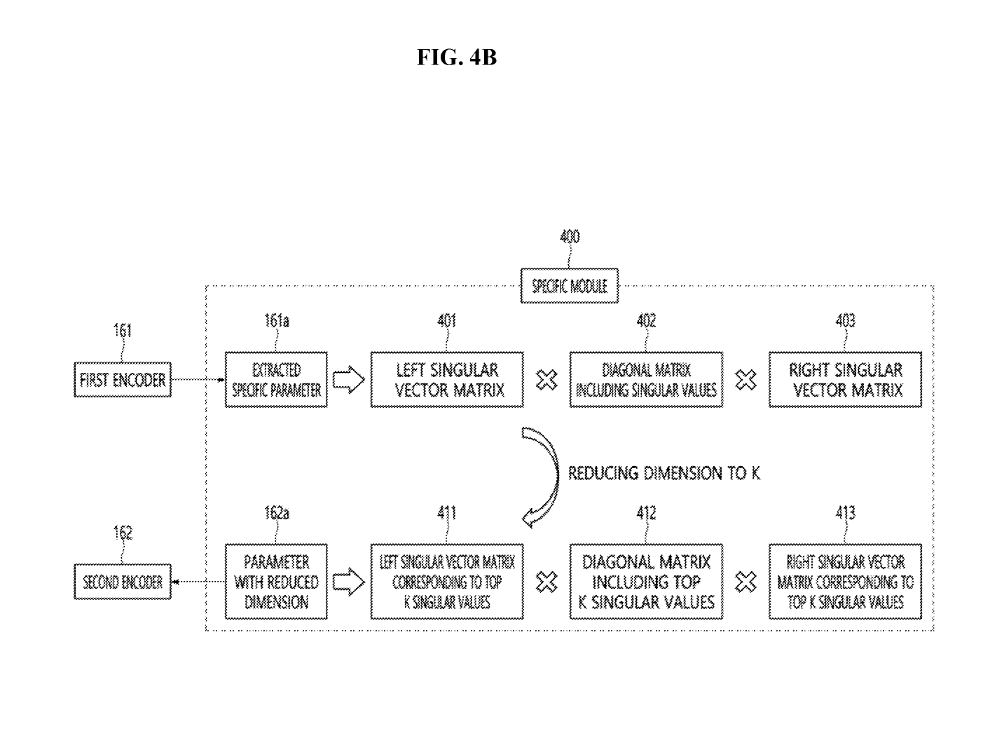

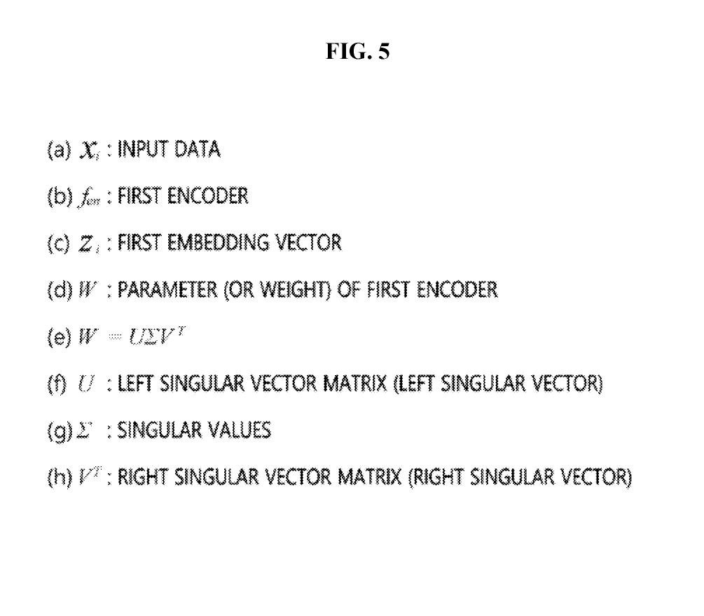

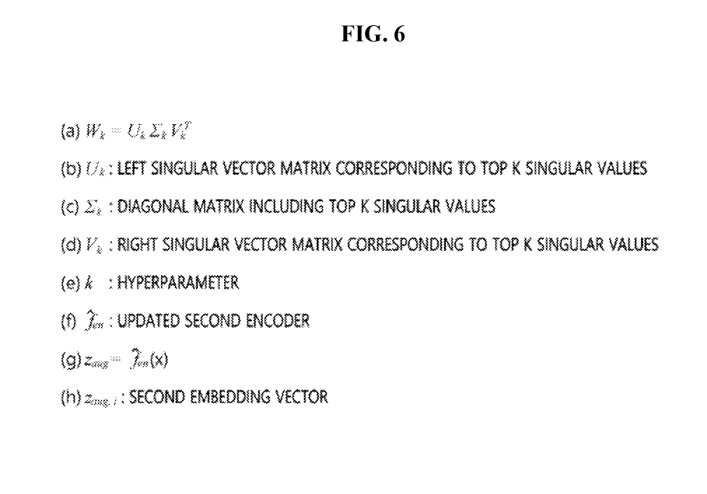

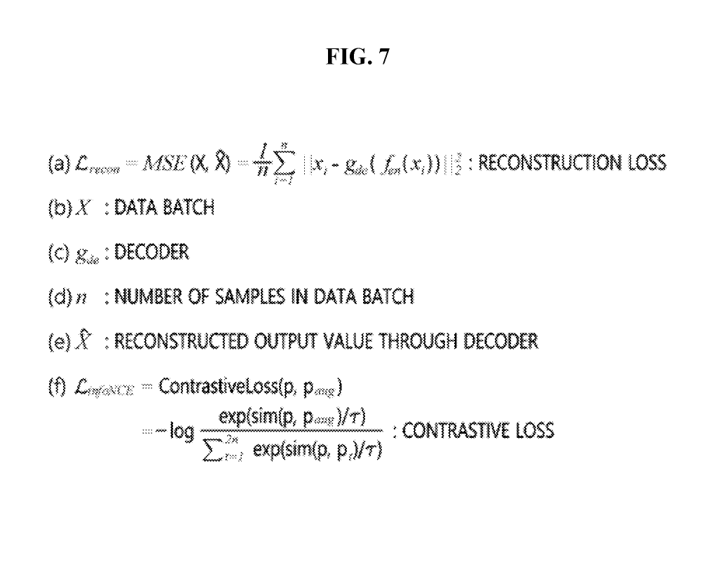

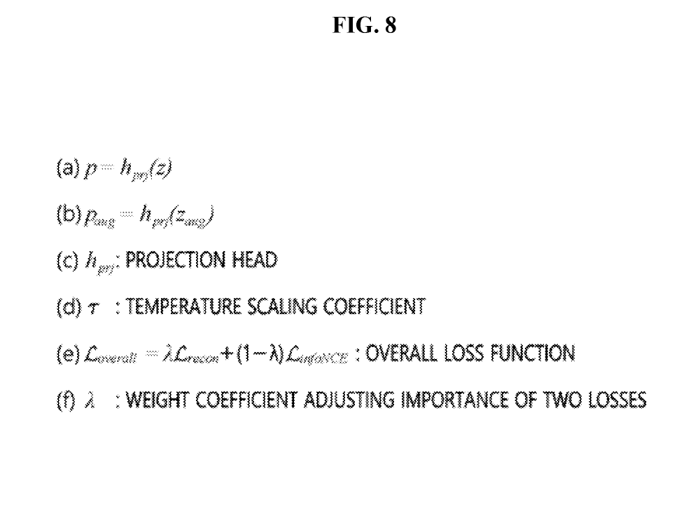

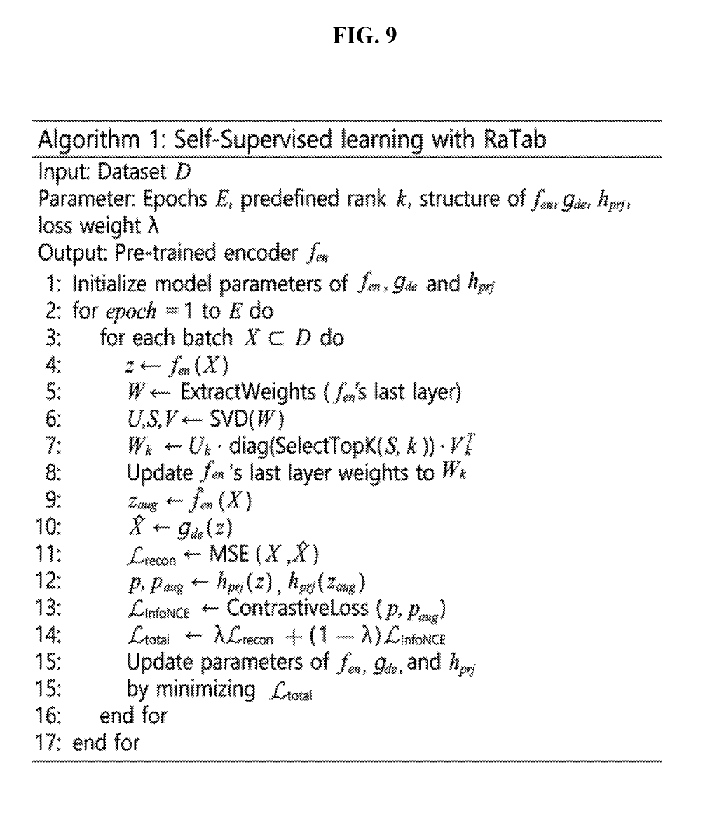

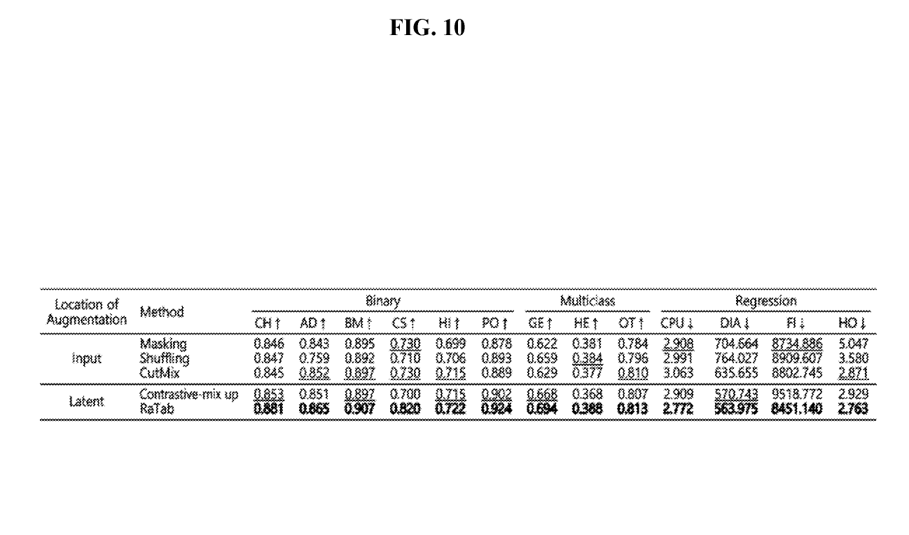

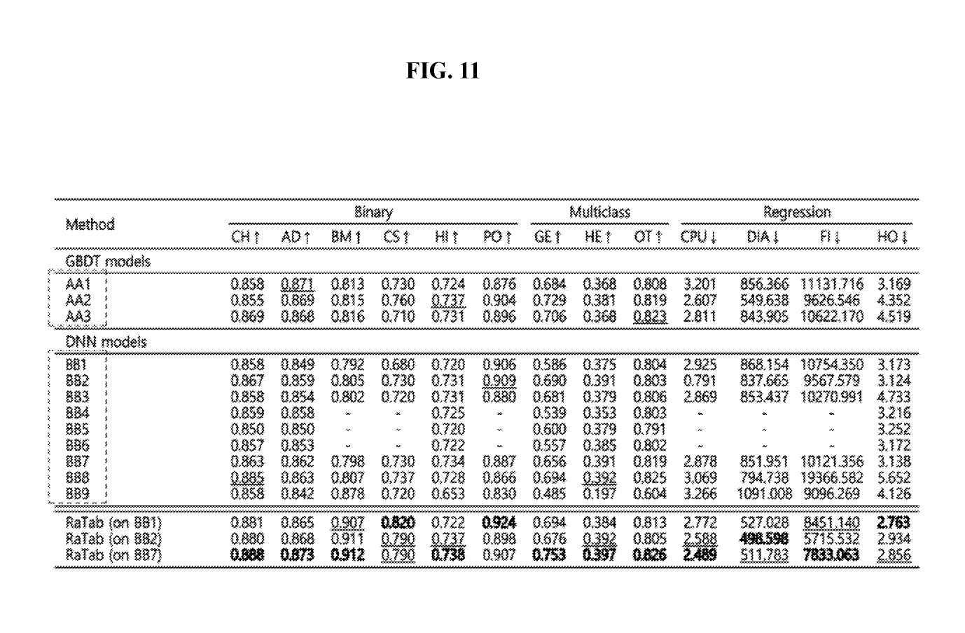

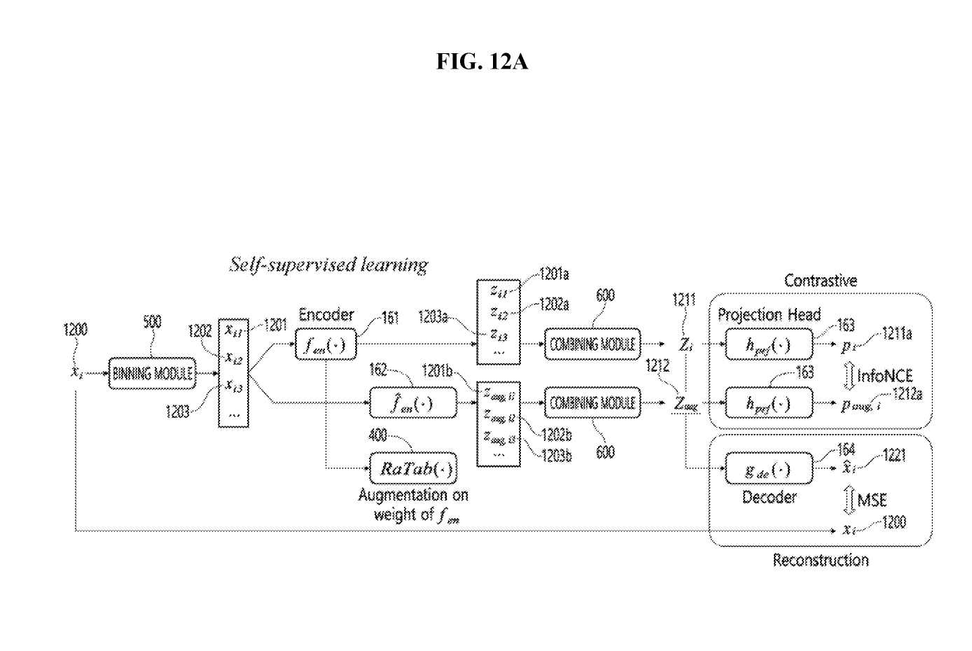

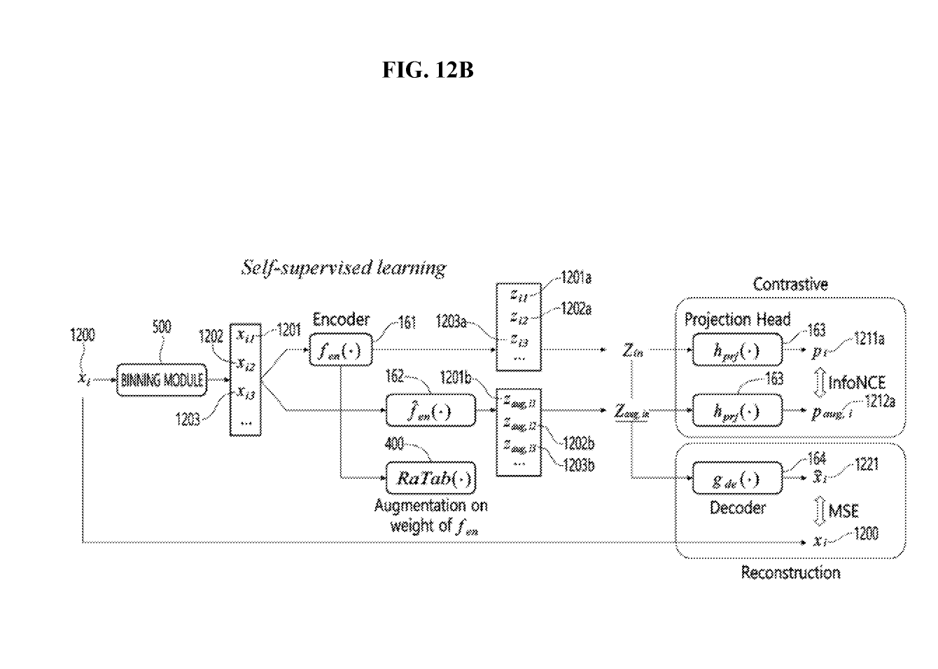

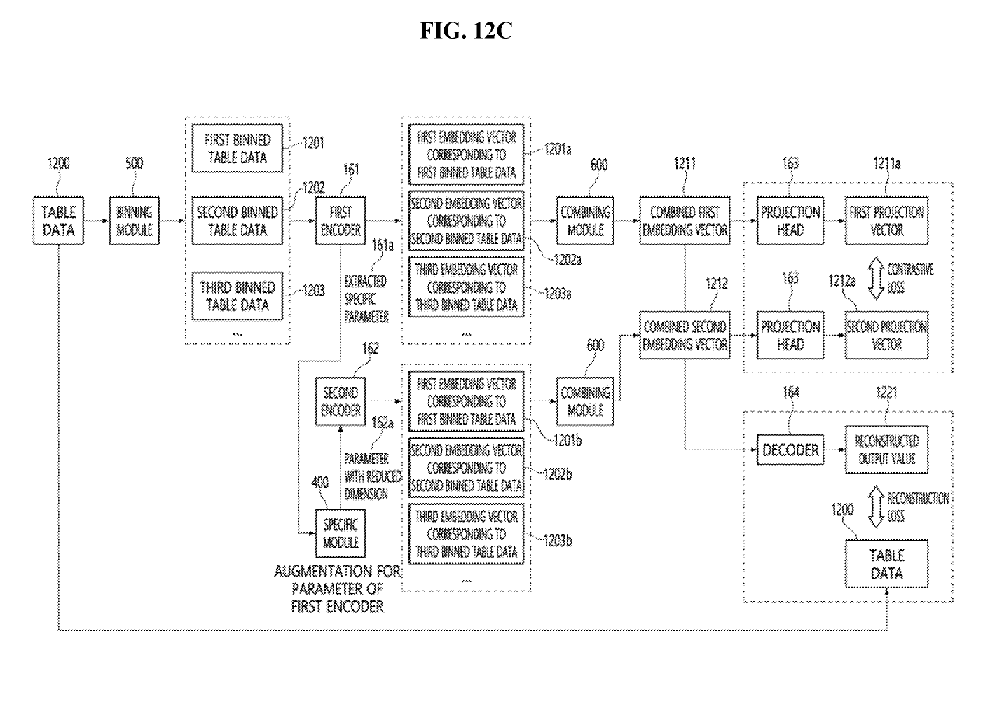

Hereinafter, embodiments of the invention will be examined more specifically together with the accompanying drawings. FIG. 1 is a conceptual diagram for describing a data augmentation system for learning of tabular data according to the embodiments of the invention. FIG. 2 is a flowchart for describing a data augmentation method for learning of tabular data according to embodiments of the invention, and FIG. 3A, FIG. 3B, FIG. 4A, FIG. 4B are conceptual diagrams for describing the data augmentation method for learning of tabular data according to the embodiments of the invention. FIG. 5, FIG. 6, FIG. 7, FIG. 8, and FIG. 9 are equations and algorithms related to the data augmentation method for learning of tabular data according to the embodiments of the invention. FIG. 10 and FIG. 11 are tables illustrating performance of the data augmentation method according to the embodiments of the invention and one embodiment of learning results of an artificial intelligence model trained by using a learning method according to the embodiments of the invention. Further, FIG. 12A, FIG. 12B, and FIG. 12C are conceptual diagrams for describing a method of training a model by performing binning for table data according to one embodiment of the embodiments of the invention.

As illustrated in FIG. 1, a data augmentation system 100 for learning of tabular data according to the embodiments of the invention (hereinafter, named as “a data augmentation system 100”) may include at least one among an input unit 110, an output unit 120, a communication unit 130, a storage unit 140, a control unit 150, and an artificial intelligence model 160.

The data augmentation system 100 according to embodiments of the invention may include at least one processor and at least one memory including a computer program code. In this case, the storage unit 140 above may serve as the memory. In embodiments of the invention, the memory and the program code may cooperate with the processor to perform a series of processes described below.

Although not illustrated, the data augmentation system 100 according to embodiments of the invention may include one or more processors, and such processors may include one or more general-purpose processors and/or one or more special-purpose processors (e.g., a digital signal processor, a tensor processing unit (TPU), a graphics processing unit (GPU), a neural processing unit (NPU), an application-specific integrated circuit, (ASIC), a field programmable gate array (FPGA), a quantum processing device (or quantum processor, QPU), etc.). One or more processors may be configured to execute instructions, computer-readable directives, and/or other commands described herein, which are stored (or included) in the storage unit 140. The method and system for data augmentation according to the embodiments of the invention may perform data processing described below through cooperation between a memory and at least one processor. The processor may perform a series of operations and data processing by using data and information stored in the memory. In this case, the memory may be a configuration of the storage unit 140.

In addition, the data augmentation system 100 according to embodiments of the invention may perform data processing and computation processes using a quantum gate, quantum entanglement, and a quantum superposition state, in consideration of implementation in a quantum computer environment. For example, embodiments of the invention may perform parallel computation based on qubits, and such quantum operations may operate complementarily with a conventional classical computer.

In case of such a quantum computer, a high-speed data processing device that utilizes parallel computation using qubits and quantum entanglement may be included, and hardware-based computation optimization using an FPGA and an ASIC is possible. In addition, in case of a quantum computer, a quantum processor capable of parallel computation based on qubits may be used, and data processing efficiency may be improved through a hybrid structure with a conventional classical computer.

The input unit 110 may serve as a means for data input, and may be configured in various types. For example, the input unit 110 may be configured to receive user input. The input unit 110 may be configured to receive user input from a user terminal 10. Here, “receiving input” may mean receiving an input signal (or selection signal) corresponding to an input of the user, based on the input being made by the user through a configuration of the input unit provided in the user terminal 10.

Here, the user terminal 10 may include at least one among a cell phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)).

In addition, in embodiments of the invention, the input unit 110 does not necessarily mean a hardware means, but may be understood as a passage for receiving input from the user.

The input unit 110 may also be referred to as a user interface module. The input unit 110 may include a touch screen, a computer mouse, a keyboard, a keypad, a touch pad, a trackball, a joystick, a voice recognition module, or other similar devices. However, in embodiments of the invention, no limitation is placed on types of the input unit 110.

Here, the user input may include a document, text, an image (or a video), voice, and the like. In this case, the data augmentation system 100 may further include a module for converting voice into text.

Next, the output unit 120 may output information through an output unit configuration (e.g., a display unit, touch screen, speaker, etc.) provided in a user terminal 10 interoperating with the data augmentation system 100 according to embodiments of the invention. For example, the output unit 120 may output a page (or service page, 1000) linked with the data augmentation system 100 according to embodiments of the invention to a display unit of the user terminal. In addition, the output unit 120 does not necessarily refer to a hardware means, but may be understood to be a channel for outputting results to a user.

Next, the communication unit 130 may be connected to the user terminal, a server (e.g., a central server, an external server, etc.), a device, and at least one network, etc. via a wireless or wired network, and may be configured to transmit or receive overall data and information required for the operation of the data augmentation system 100 according to embodiments of the invention.

The communication unit 130 may support various communication methods depending on the communication standards of devices to be communicated with.

For example, the communication unit 130 may be configured to communicate with a communication target using at least one of wireless LAN (WLAN), wireless-fidelity (Wi-Fi), wireless-fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), fifth generation mobile telecommunication (5G), Bluetooth™, radio frequency identification (RFID), infrared communication (infrared data association (IrDA)), ultra-wideband (UWB), ZigBee, near field communication (NFC), or wireless universal serial bus (wireless USB) technologies.

Next, the storage unit 140 (or a memory) may perform a role of storing various data related to the embodiments of the invention, and may include one or more non-transitory computer-readable storage media that may be read and/or accessed by at least one among the one or more processors.

The one or more computer-readable storage media may include volatile and/or non-volatile storage constituent elements such as optical, magnetic, organic, or other memory or disk storage devices. In some examples, the storage unit 140 may be implemented using a single physical device (e.g., one optical, magnetic, organic, or other memory or disk storage device), whereas in other examples, the storage unit 140 may be implemented using two or more physical devices.

The storage unit 140 may include computer-readable directives and additional data. The storage unit 140 may include storage (or repository) necessary to perform at least part of the methods, scenarios, and technologies described in this specification and/or at least part of the functions of the devices and networks.

Further, at least a part of the storage unit 140 may be a cloud storage or a cloud server. At least a part of data (e.g., table data 300) corresponding to user input received from the input unit 110 and training data may be stored in the storage unit 140.

That is, a storage unit 140 may be understood as a space in which information necessary for the operation of the data augmentation system 100 according to the embodiments of the invention is stored, and it may be understood that there is no limitation on physical space.

Further, the storage unit 140 may store a computer program including computer program instructions. Further, the storage unit 140 may store a computer program including computer program instructions that, when loaded to a processor of the system 100, control operation of the system 100 or operation of the control unit 150.

Next, the control unit 150 may perform a role of controlling overall operation of the data augmentation system 100 related to the embodiments of the invention. The control unit 150 may process signals, data, information, and the like that are input or output through the constituent elements of the data augmentation system 100 described above, or perform a series of data processing to provide or process appropriate information and functions to the user. The control unit 150 may be physically implemented by the processor described above.

Embodiments of the invention are intended to provide a method and system for data augmentation for learning of tabular data that enables an artificial intelligence model to well understand tabular data. More specifically, embodiments of the invention are intended to provide a method and a system for data augmentation for learning of tabular data such that an artificial intelligence model may learn an information-rich representation for tabular data, and, below, a method of generating a variety of augmented representations while maintaining important information of tabular data, and training an artificial intelligence model to be trained based thereon, will be described in more detail.

In embodiments of the invention, a process of inputting table data to a first encoder (S210), and obtaining, as an output of the first encoder, a first embedding vector corresponding to the table data, may be performed (S220), as shown in FIG. 2. The first encoder may be at least one first encoder, and, in the present specification, the first encoder may also be expressed as “at least one encoder”. In the present specification, for convenience, the at least one encoder is named as “the first encoder” and is described. In this case, the first encoder may be implemented as a single or a plurality of constituent elements.

As illustrated in FIG. 3A and FIG. 3B, a data augmentation method for learning of tabular data according to the embodiments of the invention may include at least one among an encoder 161, a projection head 163, and a decoder 164. In this case, at least one among the encoder 161, the projection head 163, and the decoder 164 may be a configuration included in an artificial intelligence model to be trained (hereinafter, named as “a learning target model”). Alternatively, at least one among the encoder 161, the projection head 163, and the decoder 164 may be configured separately from the learning target model. The inventive concepts are not limited to any one thereof.

In this case, in embodiments of the invention, a first encoder 161 may be configured to include a preset normalization technique. In embodiments of the invention, in order to improve diversity of a representation (or an augmented representation, an embedding, an embedding representation, an embedding vector, and the like) generated from the first encoder 161, the preset normalization technique may be applied to the first encoder 161.

For example, the preset normalization technique may include dropout. Dropout is a technique of probabilistically deactivating some neurons or randomly removing some neurons (for example, setting to 0) while a model is trained, and may be a normalization technique for preventing overfitting and increasing generalization performance of the model.

In embodiments of the invention, by using dropout, embedding may be performed into different representations even for the same input, thereby allowing noise or variability to be imparted in an embedding space. The process may be understood as a process performed because a structure of table data is fixed and, thus, augmentation of various forms is difficult unlike a general image or a general text, and generating different samples (or modifications (or transformations), a view, vectors, representations, and the like) in the embedding space is important.

In this regard, in embodiments of the invention, a magnitude (or a degree) of dropout applied to the first encoder 161 may be variously set (or applied) by a data augmentation system 100 or an administrator of the data augmentation system 100. For example, a dropout ratio of the first encoder 161 may be set to 0.1, but the set ratio is not necessarily limited thereto.

Specifically, when receiving table data 300 as an input, the first encoder 161 may be trained to generate an embedding vector corresponding to the table data 300. In this case, a control unit 150 may apply the preset normalization technique to the first encoder 161, thereby allowing stochastic variability to be imparted to an embedding vector generated (or obtained) from the first encoder 161. In embodiments of the invention, that stochastic variability is imparted to an embedding vector generated from the first encoder may also be understood as that, after the first encoder 161 is updated, stochastic variability is imparted to an embedding vector generated from the updated encoder.

Here, stochastic variability may mean a characteristic that, as dropout is applied, even for the same input, an output result is not constant and is variously changed according to a specific probability distribution. That is, a result is not probabilistically fixed and may vary according to a specific probability distribution, and may mean that a value or a state may change or be changed according to variability.

As an example, dropout may be applied to an entire layer of the first encoder 161 or a specific layer. Here, the specific layer may include at least one among a final (or last) layer of layers included in the first encoder 161 and/or a layer immediately preceding the final layer. The final layer of the first encoder 161 is a position (or a layer) converting input data into a most compressed and meaningful form of a vector, and the final layer may have a structured representation through learning. In this case, in embodiments of the invention, by utilizing dropout, a part of a parameter (or a weight, a weight matrix, a parameter matrix, and the like) included in the first encoder 161 is randomly removed, thereby allowing various data modifications to be generated.

When table data 300 is input to the first encoder 161 to which dropout is applied, the first encoder 161, as some neurons are probabilistically deactivated during learning, may generate different embedding vectors even for the table data 300 corresponding to the same input. That is, even when the same input is input to the first encoder 161, various embedding vectors may be generated due to dropout.

As described above, in embodiments of the invention, by applying dropout to an encoder, it is possible to impart natural diversity to an output generated from the encoder. This may contribute to securing a variety of augmented representations in an embedding space even without separate data augmentation. That is, embodiments of the invention secure diversity of a representation through dropout, and, through this, by allowing learning of a more robust and generalizable embedding representation, it is possible to improve performance of an entire model.

Also, in embodiments of the invention, in a contrastive learning process to be performed thereafter, it is possible to contribute to improving learning performance of the model by effectively configuring a positive pair. For example, in contrastive learning, different embedding vectors are generated from the same input data, and learning is performed by configuring the different embedding vectors as the positive pair. In this case, since, when a difference between representations is too small or too large, learning is unstable or inefficient, diversity of augmentation is required. As described above, in embodiments of the invention, even for the same input data, by applying dropout such that the encoder generates various embedding vectors, and by utilizing the various embedding vectors for contrastive learning, the model may perform more flexible and generalized learning.

Further, a control unit 150 may receive table data 300 input from a user terminal 10, and may input the received table data 300 to a first encoder 161. As another example, the control unit 150 may input table data 300 stored in a specified storage (or repository) (for example, a storage unit 140 or a memory, and the like) to the first encoder 161. Here, table data 300 corresponding to input data may be illustrated as (a) of FIG. 5, and the first encoder 161 may be illustrated as (b) of FIG. 5.

The table data 300 may be configured to include a row (or record, tuple, sample, and the like) and a column (fields, feature, characteristic, attribute, variable, predictor variable, and the like). For example, a table means a tabular data structure in a form of a table configured of rows and columns, and may be a unit for storing and managing data in a relational database. A table may be used to systematically organize and manage data like an Excel sheet or a database table. Here, a column means a set of data listed in a vertical direction in a table, and each column may indicate a specific attribute (or field) of the table. In addition, a row means one line of data listed in a horizontal direction in a table, and each row may indicate one record or tuple in the table. In addition, a column means a set of data listed in a vertical direction in a table, and each column may indicate a specific attribute (or field) of the table. That is, each row may indicate one record of a table, and each column may indicate a specific attribute of the record.

The control unit 150 may obtain, from the first encoder 161, a first embedding vector 301 corresponding to the table data 300. For example, the first encoder 161 may perform encoding for the table data 300 through parameters of multiple (or a plurality of) layers, thereby generating the first embedding vector 301 corresponding to the table data 300.

For example, the first embedding vector 301 may include at least one among i) structural information of table data 300 (position and arrangement information of rows and columns, a relationship between cells, and a hierarchical structure in table data 300 (for example, header, subheader distinction) and the like), ii) content information of a cell (content of a text value, numerical data, a symbol and the like included in each cell, type information of a cell (for example, characteristics for a data type such as a number, a string, a date and the like)), iii) context information (a context relationship from other cells around a cell, position-based information necessary for interpreting meaning of a specific cell (for example, header-data mapping) and the like), iv) interaction information between rows and columns (semantic association between columns or between rows (for example, a specific column indicates a summary of a certain purpose), information capable of inferring a pattern or a correlation at a column level or a row level, v) an overall structural or semantic summary of table data 300. That is, the first embedding vector 301 may be understood as a high-dimensional representation (or a vector, a vector value, and the like) compressing (or summarizing) a structural pattern, cell content, an interaction between features (or characteristics and the like), peripheral context information, and the like included in table data 300. In the embodiments of the invention, the first embedding vector 301 may also be named as “first representation” or “first latent vector” or “first latent representation vector” or “first feature vector” or “first hidden vector” or “first vector” or “first representation vector” or “original representation” or “original vector” and the like.

In embodiments of the invention, based on a preset extraction criterion, a process of extracting a specific parameter from the first encoder from which the first embedding vector is output (S230), and updating a second encoder based on the specific parameter extracted according to the preset extraction criterion may be performed (S240), as shown in FIG. 2. The second encoder may be at least one other encoder, and may also be expressed as “at least one other encoder”. In the present specification, for convenience, the at least one other encoder is named as “the second encoder” and is described, and the second encoder may be implemented as a single or a plurality of constituent elements. In the embodiments of the invention, “the first encoder” is, for convenience, a term referring to “at least one encoder”, and “the second encoder” is, for convenience, a term referring to “at least one other encoder”.

Here, “other encoder” means an encoder not identical to the first encoder (a physically separate constituent element or a logically distinguished module). Accordingly, in the present specification, an expression “the first encoder” refers to “at least one encoder”, and an expression “the second encoder” refers to “at least one other encoder”, and the two terms are not confused with each other. Also, each encoder may be implemented as a single or a plurality of constituent elements. Specifically, in the embodiments of the invention, encoders mentioned may be implemented as a single encoder (one), or may be implemented as a plurality of encoders (for example, two, three, four, or more). That is, in the present specification, for convenience, the encoders are named and described as “the first encoder” and “the second encoder”, respectively, but these encoders may be physically separated modules, or may be a plurality of functional units in one piece of hardware.

As illustrated in FIG. 3B, the control unit 150 may extract a specific parameter 161a of the first encoder 161 based on a preset extraction criterion. The control unit 150, based on the preset extraction criterion, may extract, from among a plurality of parameters included in the first encoder 161 trained to generate the first embedding vector 301, the specific parameter 161a of any one thereof. Alternatively, the control unit 150 may extract the specific parameter 161a from the first encoder 161 to which a preset normalization technique is applied. In this case, extraction of the specific parameter 161a from a final layer of the first encoder 161 to which the preset normalization technique is applied may also be understood.

In embodiments of the invention, extracting a parameter may also be understood as extracting a parameter matrix or a weight or a weight matrix (W). The specific parameter 161a is a trained parameter of a final layer to generate the first embedding vector 301, and may perform a role of converting an input feature into a next layer or an output. In the present specification, the specific parameter 161a may also be named as “a first parameter”. Such the specific parameter 161a may be illustrated as (d) of FIG. 5.

Here, the preset extraction criterion may be related to extracting a parameter (or a weight, a weight matrix, and the like) of a final layer (for example, an MLP layer) of the first encoder 161. The control unit 150, according to the preset extraction criterion, may extract the specific parameter 161a from the final layer among layers of the first encoder 161.

In embodiments of the invention, extracting the specific parameter 161a from the final layer of the first encoder 161 may mean extracting a last linear transformation coefficient used to generate a learned representation (that is, the first embedding vector). Compared to an initial layer of the first encoder 161, the specific parameter 161a of the final layer may include a high-dimensional relationship between input features and abstracted information. Such the specific parameter 161a may be a core structure (or a constituent element) of information compression and abstraction involved in that the first encoder 161 converts the table data 300 into the first embedding vector 301. That is, extracting the specific parameter 161a from the final layer of the first encoder 161 may be understood as securing a most important embedding-space structure learned by the first encoder 161, thereby enabling balanced representation augmentation between information preservation and diversity based thereon.

As illustrated in FIG. 3A and FIG. 3B, the control unit 150 may input the extracted the specific parameter 161a to a preset specific module 400. The specific module 400 may be included in a configuration of the learning target model, or may be configured separately from the learning target model (in this case, being included as a configuration of the data augmentation system 100). In the present specification, the specific module 400 may also be named as “an augmentation module”, “a data augmentation module”, “a parameter update module”, “an encoder update module”, “a representation-space augmentation module”, “a representation-space augmentation model”, “a RaTab (representation-space augmentation for tabular data) augmentation module”, “a RaTab augmentation model”, and the like.

The specific module 400 may be a module configured to perform decomposition for the specific parameter 161a by using a preset decomposition method. For example, the preset decomposition method may include at least one among singular value decomposition (SVD) and truncated (or reduced) singular value decomposition (SVD).

Here, singular value decomposition is a method of decomposing a matrix into a product of three matrices, and, for example, may be understood as a method of decomposing a weight matrix into a product of three matrices. Singular value decomposition divides the weight matrix into three interpretable components, thereby performing a role of separating a structural pattern of information. Also, truncated singular value decomposition is a method of selecting only a most important part among results of singular value decomposition to approximate an original weight matrix, and, for example, may be understood as a method of enabling dimensionality reduction and information compression by selecting only a top partial numbers (k pieces) among all singular values and singular vectors calculated through singular value decomposition.

The specific parameter 161a extracted from the first encoder 161 may be a parameter optimized to learn a representation derived from input data (that is, the table data 300). The specific parameter 161a may reflect, in an implicit manner, composite information such as variance of the table data 300, correlation, an important feature (characteristic, or the like) direction, an inter-variable interaction structure of the table data 300, and the like. That is, the specific parameter 161a is a learning result reflecting statistical and/or structural characteristics of the table data 300, and, in this case, since singular value decomposition is a process of extracting an important direction (or a pattern) among the structure, important relatedness of the table data 300 may be reflected.

The specific module 400 may decompose a parameter 161a (or a weight, a weight matrix, and the like) extracted from the first encoder 161 by using singular value decomposition. A plurality of matrices decomposed through singular value decomposition for such the specific parameter 161a may be illustrated as (e) of FIG. 5.

More specifically, as illustrated in FIG. 4A and FIG. 4B, the specific module 400 may decompose the specific parameter 161a into a product of a plurality (three) of matrices. The specific module 400 may decompose the specific parameter 161a into at least one among a first singular vector matrix 401 (or a left singular vector matrix (Left Singular Vector)) including a first singular vector, a second singular vector matrix 403 (or a right singular vector matrix (Right Singular Vector)) including a second singular vector, and a diagonal matrix 402 including a singular value corresponding to the first singular vector and the second singular vector, respectively. Here, the first singular vector matrix 401 may be illustrated as (f) of FIG. 5, the diagonal matrix 402 including a singular value may be illustrated as (g) of FIG. 5, and the second singular vector matrix 403 may be illustrated as (h) of FIG. 5.

Singular value decomposition is a decomposition of a structure included in the specific parameter 161a corresponding to a result of learning of the table data 300 by the first encoder 161, and a plurality of matrices obtained through singular value decomposition may each include elements describing various information included in the table data 300 (for example, an inter-variable structure, correlation, an important axis, a representation dimension, and the like).

The first singular vector matrix 401 may also be understood as an orthogonal matrix configured to include the first singular vector. For example, the first singular vector matrix 401 may indicate, when the table data 300 is converted, to which output direction (for example, a hidden dimension) important information is projected. The first singular vector matrix 401 may indicate to which direction of a representation space each row (or sample) is summarized. That is, the first singular vector matrix 401 may indicate to which vector direction of meaning a specific sample is projected. Such the first singular vector matrix 401 may be understood as a central directional axis for generating a row-based embedding vector.

The diagonal matrix 402 is a matrix in which singular values are arranged in descending order (or singular values are arranged on a diagonal line), and each singular value may indicate a magnitude in an important-axis direction of the specific parameter 161a. The diagonal matrix 402 may include information expressing, as a quantitative magnitude, how much feature information each axis (or basis direction) explains (that is, an importance order of a column structure). In this case, as a singular value is larger, a corresponding direction (or basis) may be understood as better describing the table data 300. For example, when a first singular value is large, it may indicate that most of variance of the table data 300 is concentrated on a first basis axis. That is, it may quantitatively indicate which column combination in the table data 300 describes major information or is important.

The second singular vector matrix 403 is a transpose matrix of a second singular vector, and may include axis-direction information of an input feature space. The second singular vector matrix 403 may form a fundamental axis in singular value decomposition. For example, the second singular vector matrix 403 may include information on in which direction each column (or feature) included in the table data 300 is combined to form a major information axis. Here, an axis is a direction in a vector space, and may be formed by a combination of column directions (or a feature space) (that is, an axis is an important directionality made by combining features). That is, the second singular vector matrix 403 may include information indicating correlation, a coupling structure, a statistical structure, dependency, and the like between columns of the table data 300.

In one embodiment, columns of the table data 300 may be determined, through the diagonal matrix 402 and the second singular vector matrix 403, as to which combination is important, and rows of the table data 300 may be determined, through the first singular vector matrix 401, as to how the rows are projected onto the important combination. Singular value decomposition may be a process of summarizing a structure of a column (or a variable), and, based thereon, projecting a row onto a new embedding space.

The specific module 400 may perform low-rank approximation based on singular value decomposition for the specific parameter 161a extracted from the first encoder 161, such that only a singular value satisfying a preset criterion (or a preset ratio criterion) and a vector corresponding to the singular value are maintained. For example, low-rank approximation is a technique of approximating high-dimensional data in a low-dimensional form, and may be used to reduce a size of data while maintaining a core structure and information of original data. In a case of a matrix, by approximating the matrix with a low-rank matrix, it is possible to reduce a storage space and a computation cost while preserving major information of an original matrix. That is, low-rank approximation may simplify data into a form capable of removing noise and better understanding the data by finding a low-rank approximation value for original data. In this process, while reducing a dimension of data, important information may be preserved as much as possible.

Specifically, the specific module 400 may specify (or select) at least one specific singular value satisfying the preset criterion, and may generate a new parameter to be used for updating a second encoder 162 based on the specified (or selected) singular value.

Here, the preset criterion may be related to satisfying the leading top-k. In embodiments of the invention, k may be set as a certain ratio (p%) relative to an entire rank. As an example, a value of p may be selected from among a first value (50%), a second value (60%), and a third value (70%). When p = 0.6, only 60% of entire singular values may be maintained, and, when p = 0.7, only 70% of entire singular values may be maintained. In this case, k may also be understood as a hyperparameter (see (e) of FIG. 6), and such a hyperparameter may determine a rank to be maintained. The hyperparameter may control to what extent important information is preserved in a latent representation. It is obvious that such the preset ratio criterion is not limited to any one thereof and may be variously changed by the data augmentation system 100 or an administrator of the data augmentation system 100.

As described above, singular values included in the diagonal matrix 402 may be arranged in descending order. As a singular value is larger, it may mean that an amount of information (or variance) occupied by a corresponding axis (a singular-vector direction) in the table data 300 is large. That is, a largest singular value explains much variance of the table data 300, and this may correspond to an important pattern or structure. On the other hand, a small singular value may explain an axis direction (for example, noise or a fine pattern) that is not important in the table data 300. Therefore, specifying (or selecting) a specific singular value satisfying the preset criterion may also be understood as meaning preserving most important information (a principal component direction).

The specific module 400 may specify, in order to maintain a singular value satisfying the preset criterion among the singular values, a singular value (or a specific singular value) satisfying the preset criterion, and a first singular vector and a second singular vector corresponding to the singular value satisfying the preset criterion. The specific module 400, in order to maintain a singular value satisfying the preset criterion among singular values corresponding to each of the first singular vector and the second singular vector, may specify a singular value satisfying the preset criterion, and may specify the first singular vector (or a specific first singular vector) and the second singular vector (or a specific second singular vector) corresponding to the specified singular value, thereby maintaining the specified singular value and the specified the first singular vector and the second singular vector.

Alternatively, the specific module 400 may reduce a dimension (for example, reduce to k) of the first singular vector matrix 401, the diagonal matrix 402, and the second singular vector matrix 403, in order to allow only a specified singular value and a first singular vector and a second singular vector corresponding to the specified singular value to be maintained.

For example, the specific module 400 may specify a first singular vector satisfying a preset criterion among first singular vectors included in the first singular vector matrix 401. Further, the specific module 400 may reduce a dimension of the first singular vector matrix 401, in order to maintain such that the specified the first singular vector (or top k first singular vectors) continues to be included in the first singular vector matrix 401, and to remove (or exclude) remaining the first singular vectors other than the specified the first singular vector. A low-dimensional first singular vector matrix of which a dimension is reduced (or a left singular vector matrix corresponding to top k singular values, a first singular vector matrix configured of a specified the first singular vector, and the like, 411) may be illustrated as FIG. 4A and (b) of FIG. 6.

As another example, the specific module 400 may specify a singular value satisfying the preset criterion among singular values included in the diagonal matrix 402. Further, the specific module 400 may reduce a dimension of the diagonal matrix 402, in order to maintain such that the specified singular value (or top k singular values) continues to be included in the diagonal matrix 402, and to remove remaining singular values other than the specified singular value. A low-dimensional diagonal matrix of which a dimension is reduced (or a diagonal matrix including top k singular values, a diagonal matrix configured to include a specified singular value, and the like, 412) may be illustrated as FIG. 4A and (c) of FIG. 6.

As still another example, the specific module 400 may specify a second singular vector satisfying the preset criterion among second singular vectors included in the second singular vector matrix 403. Further, the specific module 400 may reduce a dimension of the second singular vector matrix 403, in order to maintain such that the specified the second singular vector (or top k second singular vectors) continues to be included in the second singular vector matrix 403, and to remove remaining the second singular vectors other than the specified the second singular vector. A low-dimensional second singular vector matrix of which a dimension is reduced (or a right singular vector matrix corresponding to top k singular values, a second singular vector matrix configured of a specified the second singular vector, and the like, 413) may be illustrated as FIG. 4A and (d) of FIG. 6.

Further, the specific module 400 may generate a parameter based on at least one among the specified singular value, the specified the first singular vector, and the second singular vector. The specific module 400 may generate (or output) a new parameter to be used for updating a second encoder 162, based on at least one among the low-dimensional first singular vector matrix 411, the low-dimensional diagonal matrix 412, and the low-dimensional second singular vector matrix 413.

In this case, a process of generating a new parameter to be used for updating may be a process of performing a low-rank approximation based on singular value decomposition for the specific parameter 161a extracted from the first encoder 161, thereby approximating to a low-dimensional parameter (or a weight, a weight matrix, a parameter matrix, and the like) that preserves only components satisfying the preset criterion. Alternatively, while preserving important information, the process may be a process of modifying the specific parameter 161a into a new parameter (Wk, 162a) based on at least one among the specified singular value, the specified the first singular vector, and the second singular vector. Here, preserving important information means that singular value decomposition is performed centered on a direction capable of well describing the table data 300, and, in this case, the direction may be a direction with smallest variance. The specific module 400 may preserve important information based on such directions with small variance.

That is, the specific module 400, in order to preserve important information (or core information) of the table data 300, after performing singular value decomposition for the specific parameter 161a of a final layer of the first encoder 161, may approximate to a low-dimensional parameter preserving only a singular value satisfying the preset criterion and a first singular vector and a second singular vector corresponding to the singular value.

For example, as illustrated in FIG. 4A and FIG. 4B, a parameter 162a generated from the specific module 400 may be generated through a multiplication of the low-dimensional first singular vector matrix 411, the low-dimensional diagonal matrix 412, and the low-dimensional second singular vector matrix 413. A parameter 162a corresponding to an output of the specific module 400 may also be named as “an updated parameter”, “a dimension-reduced parameter”, “an information-reduced parameter”, “a low-dimensional parameter”, “a second parameter”, “a truncated parameter”, “a modified parameter”, “an updated weight matrix”, “a dimension-reduced weight matrix”, “a low-dimensional weight matrix”, “a second weight matrix”, “a truncated weight matrix”, “a modified weight matrix”, or “an information-reduced weight matrix”, and the like. Such a parameter 162a may be illustrated as (a) of FIG. 6.

The control unit 150 may update the second encoder 162 by using an output of the specific module 400 for the specific parameter 161a. A parameter 162a corresponding to an output from the specific module 400 may be used for updating the second encoder 162.

As illustrated in FIG. 4B to FIG. 5B, the control unit 150 may update the second encoder 162 by using the parameter 162a, in order to obtain (or generate) a second embedding vector 302.

Here, a process of updating the second encoder 162 may be a process of inputting the parameter 162a output from the specific module 400 to the second encoder 162, and setting a parameter of the second encoder 162 as the parameter 162a output from the specific module 400. Alternatively, the process may be a process of updating the specific parameter 161a of the final layer of the first encoder 161 to the parameter 162a output from the specific module 400. Alternatively, the process may be a process of updating the specific parameter 161a of the final layer of the first encoder 161 to the parameter 162a output from the specific module 400. Alternatively, the process may be a process of inputting the parameter 162a output from the specific module 400 to the first encoder 161, and setting the specific parameter 161a of the first encoder 161 as the parameter 162a output from the specific module 400, thereby newly configuring an updated second encoder 162.

Further, in embodiments of the invention, a process of inputting table data to the updated second encoder (S250), and obtaining an augmented second embedding vector corresponding to the table data from the second encoder may be performed (S260), as shown in FIG. 2..

An update process of the second encoder 162 described above may be a process of updating the second encoder 162 by using an output of the specific module 400, in order to generate an augmented new embedding vector (or the second embedding vector) for the first embedding vector 301 (or with respect to the first embedding vector 301, from the first embedding vector 301, etc.) obtained from the first encoder 161. Alternatively, the process may be a process of updating the second encoder 162 by using an output of the specific module 400, in order to generate a positive representation (or a positive view, a positive sample, a positive modification (or transformation), and the like) for the first embedding vector 301 obtained from the first encoder 161.

The updated second encoder 162 may be configured to generate an augmented second embedding vector corresponding to the table data 300 based on the set parameter 162a. The updated second encoder 162 may be illustrated as (f) of FIG. 6.

In this case, the updated second encoder 162 may be an encoder to which dropout is applied. As described above, since the second encoder 162 is updated based on the parameter 161a extracted from the first encoder 161 to which dropout is applied, the updated second encoder 162 may be configured to include dropout applied to the first encoder 161.

When receiving table data 300 as an input, the second encoder 162 may be trained to generate an embedding vector (for example, the second embedding vector) corresponding to the table data 300. In this case, when a preset normalization technique is applied to the second encoder 162, stochastic variability may be imparted to an embedding vector generated (or obtained) from the second encoder 162. For example, when table data 300 is input to the second encoder 162 to which dropout is applied, the second encoder 162, as some neurons are probabilistically deactivated during learning, may generate different embedding vectors even for the table data 300 corresponding to the same input. That is, even when the same input is input to the second encoder 162, various embedding vectors may be generated due to dropout. That is, the second encoder 162 to which the preset decomposition method and the preset normalization technique are applied may generate various embedding vectors even for the table data 300 corresponding to the same input.

As illustrated in FIG. 3A and FIG. 3B, the control unit 150 may input the table data 300 to the second encoder 162, and may obtain the second embedding vector 302 corresponding to the table data 300 from the second encoder 162. The second embedding vector 302 may be illustrated as (g) and (h) of FIG. 6. For example, the second embedding vector 302 may include at least one among i) structural information of the table data 300 (arrangement of rows and columns, correlation between columns, a structural attribute such as a data type (a numerical type, a categorical type, and the like), and the like, a representation for a hierarchical structure of the table data 300 (a header/a subheader, column grouping, and the like), and the like), ii) content information at a cell level and a feature level (an embedded representation of numerical/categorical values included in each feature (that is, a semantically reconstructed vector rather than a raw value)), iii) a semantic relationship on a latent space (a compressed or refined representation based on an axis (a principal component) having a highest amount of information in a table through a major axis direction maintained by singular value decomposition diversity within the same class, a representation suitable for boundary learning between different classes, and the like), and iv) interaction information between multiple features (a nonlinear relatedness and a covariance structure between different columns in a table, an important relational axis between features in a high-dimensional space, and the like). That is, the second embedding vector 302 may be understood as a high-dimensional representation (or a vector, a vector value, and the like) having diversity and distinctiveness of a representation, while maintaining a structure, content, a relationship, a pattern, and a semantic axis of the table data 300, rather than raw data for the table data 300. In embodiments of the invention, the second embedding vector 302 may also be named as “a second latent vector”, “a second latent representation vector”, “a second feature vector”, “a second hidden vector”, “a second vector”, “a second representation vector”, “an augmented representation”, “an augmented vector”, “a second representation”, and the like.

Such the second embedding vector 302 includes, compared to the first embedding vector 301 described above, a compressed feature centered on a principal component, thereby improving diversity and generalization performance on a representation space. For example, the second embedding vector 302 is a representation generated through the second encoder 162 configured based on a truncated singular value decomposition result in which singular value decomposition is performed for the specific parameter 161a of a final layer of the first encoder 161 corresponding to the first embedding vector 301, and only a top partial number (top k pieces) of singular values calculated therefrom and a corresponding principal-axis direction vector (a principal component) are preserved. In this case, since truncated singular value decomposition is configured to selectively preserve important structural information centered on a principal component direction having high variance among an embedding space (or an entire representation space) of the first encoder 161, the second embedding vector 302 has a characteristic of appearing in a form in which, while an amount of information is reduced compared to the first embedding vector 301, core information and semantic features in the embedding space are emphasized.

Also, diversity of a representation of the second embedding vector 302 may be strengthened by stochastic variability of dropout applied to the encoder. For example, since the second embedding vector 302 is generated from the second encoder 162 to which dropout is applied, it is possible to generate various representations as a neuron deactivation configuration within the encoder is probabilistically changed even for the same input. Such stochastic variability increases representation diversity on a latent space, thereby contributing to expanding a distribution width of a representation and intra-class variance while maintaining semantic similarity between positive pairs during self-supervised learning. As a result, this enables more robust and generalizable representation learning in contrastive learning.

Thereafter, the control unit 150 may configure (or set) the first embedding vector 301 and the second embedding vector 302 as one positive pair, thereby optimizing, in parallel, a contrastive loss maximizing similarity between the two vectors and a reconstruction loss reconstructing input data based on an original representation.

More specifically, as described above, the control unit 150 may generate different embedding vectors (that is, an augmented second embedding vector 302 different from the first embedding vector 301) by using the updated second encoder 162 updated based on the specific parameter 161a of the first encoder 161 generating the first embedding vector 301. That is, even for the table data 300 that is the same input, different the first embedding vector 301 and the second embedding vector 302 are generated through augmentation, and, in this case, the second embedding vector 302 may be a vector represented differently from the first embedding vector 301 due to a structure of a parameter 162a of the updated second encoder 162 and dropout. That is, the first embedding vector 301 and the second embedding vector 302 generated for the same the table data 300 may be mapped to different embedding spaces (or positions), and a distance between the first embedding vector 301 and the second embedding vector 302 may be appropriately maintained for contrastive learning. Here, that a distance is appropriately maintained may be understood as, since the first embedding vector 301 and the second embedding vector 302 are vectors generated for the same input data, the first embedding vector 301 and the second embedding vector 302 are maintained close to an extent of including the same meaning (that is, being capable of belonging to the same label).

In this manner, in embodiments of the invention, by using different the first embedding vector 301 and the second embedding vector 302 as a positive pair, it is possible to maximize an effect of SSL learning and secure diversity and robustness of a representation at the same time. More detailed contents thereof will be described later.

As described above, in embodiments of the invention, by augmenting data based on singular value decomposition meaningful augmentation is generated in the embedding space, and, in this case, while preserving important information of the table data, it is possible to augment (or generate) various representations. In particular, embodiments of the invention, by being combined with diversity due to dropout, may further improve robust and generalizable representation learning of a model.

That is, embodiments of the invention, in order to preserve an important structure in a data augmentation process, maintains important information by focusing on a most important intrinsic-space direction through truncated singular value decomposition, and, through a probabilistic characteristic of dropout, introduces variability in the augmentation process, thereby generating various representations.

In embodiments of the invention, a process of training the learning target model by using the first embedding vector and the second embedding vector may be performed (S270, see FIG. 2).

For training of the learning target model (or a module), the control unit 150 may define a first loss function and a second loss function, respectively, by using at least one among the first embedding vector and the second embedding vector.

First, as illustrated in FIG. 3A and FIG. 3B, the control unit 150 may input, to the projection head 163, the first embedding vector 301 and the second embedding vector 302, respectively. In this case, the control unit 150 may configure the first embedding vector 301 and the second embedding vector 302 as one positive pair (or pair), and may train the learning target model by using positive pair including the first embedding vector 301 and the second embedding vector 302 (or positive pair in which the first embedding vector 301 and the second embedding vector 302 form a pair). The first embedding vector 301 and the second embedding vector 302 generated for the same the table data 300 belong to the same label (for example, a positive label), but may indicate different views. Here, different views mean that a method in which data is represented is different, and, for example, the first embedding vector 301 may be a representation generated through original weights of the encoder based on the same the table data 300, and the second embedding vector 302 may be a representation generated in a state in which, based on the same the table data 300, SVD (singular value decomposition) is applied to a last layer of the encoder or dropout is applied to partially modify weights. In this manner, two vectors generated from the same data but having a difference in a generation process have different representation methods (different views), and this allows presence at different positions on a representation space while maintaining the same meaning.

The projection head 163 may convert the first embedding vector 301 and the second embedding vector 302, respectively, into a low-dimensional (or a low dimension, a smaller dimension, and the like) space, and, as results of projecting (or casting, and the like) the first embedding vector 301 and the second embedding vector 302, respectively, may output (or generate) a first projection vector 311 corresponding to (or for) the first embedding vector 301 and a second projection vector 312 corresponding to the second embedding vector 302.

The control unit 150 may obtain, from the projection head 163, the first projection vector 311 corresponding to the first embedding vector 301 and the second projection vector 312 corresponding to the second embedding vector 302. Further, the control unit 150 may define the first loss function for contrastive learning by using the first projection vector 311 and the second projection vector 312. The first loss function may also be named as “a contrastive loss function”, and the like. Such the first loss function may be illustrated as (f) of FIG. 7. Here, the first projection vector 311 may be illustrated as (a) of FIG. 8, the second projection vector 312 may be illustrated as (b) of FIG. 8, and the projection head 163 may be illustrated as (c) of FIG. 8. Also, in the first loss function, a temperature scaling coefficient may be illustrated as (d) of FIG. 8.

The first loss function may be defined to learn similarity between the first embedding vector 301 and the second embedding vector 302. For distinguishing (or identifying, classifying, detecting, and the like) a difference between features, the control unit 150 may train at least one among the first encoder 161 and the projection head 163 by using the first loss function.

By using the first loss function, the control unit 150 may calculate a contrastive loss (or a first loss, a contrastive loss value, a first loss value, and the like) based on similarity between the first projection vector 311 and the second projection vector 312, and may update a parameter of at least one among the first encoder 161 and the projection head 163 based on the calculated contrastive loss.

That is, at least one among the encoder 161 and the projection head 163 may calculate similarity between the first projection vector 311 and the second projection vector 312 by using the first loss function, and may be trained in a direction of maximizing similarity between the first projection vector 311 and the second projection vector 312.

That is, the first encoder 161 or the projection head 163 may learn similarity between the first embedding vector 301 corresponding to the table data 300 and the augmented the second embedding vector 302. This may be understood as maximizing (making close) similarity between the first embedding vector 301 generated for the same the table data 300 and the augmented the second embedding vector 302, and learning such that similarity with an embedding vector generated for the table data 300 different from the table data is minimized (made far).

Next, as illustrated in FIG. 3A and FIG. 3B, the control unit 150 may input the first embedding vector 301 to the decoder 164. The decoder 164 may perform a role of restoring the first embedding vector to correspond to an original input data form. The decoder 164 may reconstruct the first embedding vector 301 to correspond to the table data 300, thereby generating a reconstructed output value 321. This may be understood as an output value for determining similarity with the table data 300 corresponding to an input.

The control unit 150 may obtain the reconstructed output value 321 from the decoder 164, and may define a second loss function for reconstruction learning by using the table data 300 and the reconstructed output value. The second loss function may also be named as a reconstruction loss function. Such the second loss function has an object to model a relationship within a sample, and may be illustrated as (a) of FIG. 7. Here, a data batch may be illustrated as (b) of FIG. 7, the decoder 164 may be illustrated as (c) of FIG. 7, the number of samples in a data batch may be illustrated as (d) of FIG. 7, and the reconstructed output value 321 through the decoder 164 may be illustrated as (e) of FIG. 7.

The second loss function may be defined to learn a relationship between the table data 300 and the reconstructed output value 321. By using the second loss function, the control unit 150 may train at least one among the first encoder 161 and the decoder 164.

By using the second loss function, the control unit 150 may calculate a reconstruction loss (or a second loss, a reconstruction loss value, a second loss value, and the like) between the table data 300 and the reconstructed output value 321, and may update a parameter of at least one among the first encoder 161 and the decoder 164 based on the calculated reconstruction loss.

That is, at least one among the first encoder 161 and the decoder 164 may learn a relationship between the table data 300 and the reconstructed output value 321 by using the second loss function. Here, learning a relationship between the table data 300 and the reconstructed output value 321 may mean that at least one among the first encoder 161 and the decoder 164 is trained to understand and represent the structure and the feature to an extent of being able to restore the table data 300 input as input data again. That is, through a process of converting the table data 300 into the first embedding vector 301 and then restoring the table data, it is possible to be trained to identify a structure of original data and reconstruct the structure.

Further, the control unit 150 may define a final loss function (or an overall loss function) by using the first loss function and the second loss function, and may train the learning target model by using the final loss function. In this case, a process of training the learning target model by using the final loss function may also be understood as a process of updating a parameter of at least one among the first encoder 161, the projection head 163, and the decoder 164 such that a difference between a first loss value and a second loss value calculated by calculating the first loss function and the second loss function included in the final loss function, respectively, is minimized.

The final loss function may be defined as a weighted combination (or a weighted sum) of the first loss value calculated by using the first loss function and the second loss value calculated by using the second loss function. Here, the final loss function may be illustrated as (e) of FIG. 8, and a weight coefficient adjusting importance of the first loss and the second loss may be illustrated as (f) of FIG. 8.

After a pre-training process (for example, SSL) using the final loss function is ended, the control unit 150 may fine-tune the first encoder 161 after removing at least one among the remaining the projection head 163 and the decoder 164 excluding the first encoder 161. In a fine-tuning process, by using a dataset including (or assigned) a label, refinement for task-specific performance improvement may be performed. In such a fine-tuning process, the first encoder 161 is set to a state capable of being trained again, and, by being trained together with a new learning target model, a parameter of the first encoder 161 may be fine-tuned to be adapted better to a specific task performed by the learning target model. For example, the trained first encoder 161 may be connected to the learning target model and used for training of the learning target model, and, in this case, the control unit 150 may train the learning target model based on the trained first encoder 161. In this case, the learning target model may be a model separately defined to perform a preset task (for example, prediction or classification or regression, and the like), and may also be configured in a structure separate from the trained first encoder 161.

For example, the learning target model may include at least one among a classification model (or a classification module, a classifier, and the like) and a regression model (or a regression module) using the encoder (for example, the first encoder 161) as a backbone in order to perform a downstream task such as prediction or classification or regression for tabular data. Alternatively, the learning target model may include at least one among a multi-layer perceptron (MLP) based model, an FT-Transformer based model, and a T2G-Former based model. However, a type of the learning target model is not limited only to the examples mentioned above, and may further include various models.

In one embodiment, when the trained first encoder 161 is connected to the learning target model, it is possible to obtain a first embedding vector corresponding to the table data and an augmented second embedding vector from the trained first encoder 161, and train the learning target model by using the obtained the first embedding vector and the second embedding vector.

Finally, through the method described above, the trained artificial intelligence model 160 may detect, by integrating an object of reconstruction learning and contrastive learning, a complex feature interaction and a relationship between samples effectively, and the trained artificial intelligence model 160 may be applied to an industry and a service using various tabular data, thereby being usefully utilized. Also, since the learning method according to embodiments of the invention is applied only to a final layer of the encoder, compatibility with any encoder structure is possible.

A process for a data augmentation method and system according to embodiments of the invention described above, and a learning method of the artificial intelligence model 160 may also be illustrated as an algorithm of FIG. 9. For example, after initializing parameters of the encoder, the decoder, and the projection head, iterative training is performed during an entire training epoch. In each epoch, data is loaded in a batch unit, and, for each batch, input data is embedded by applying the encoder. Thereafter, a weight existing in a last layer of the encoder is extracted, and singular value decomposition (SVD) is performed for the weight, thereby identifying a major structure. Among an SVD result, top-rank information is selected to reconstruct the weight, and a last-layer weight of the encoder is updated to the value. Further, through the updated encoder, the same input batch is embedded again, thereby obtaining an augmented representation. A restoration result is generated by passing the original representation and the augmented representation through the decoder, respectively, and mean-squared-error (MSE) between the original input and the restored input is calculated. Also, a contrastive loss between the two representations is calculated by passing an original embedding and an augmented embedding through the projection head, respectively. Further, a final loss is configured as a weighted sum of a reconstruction loss and a contrastive loss, and parameters of the encoder, the decoder, and the projection head are updated so as to minimize a reconstruction loss value and a contrastive loss value. By repeating such a process for all batches and epochs, an encoder securing representation diversity while preserving various structural information is pre-trained.

In one embodiment, as illustrated in FIG. 10, it can be confirmed that the data augmentation method according to embodiments of the invention examined above shows superior performance over other methods, including all tasks and datasets. That is, the data augmentation method according to embodiments of the invention shows consistently superior performance even in various tasks and datasets, and this may indicate that the augmentation method according to embodiments of the invention is effective.

In another embodiment, as illustrated in FIG. 11, confirmation can be made that the data augmentation method according to embodiments of the invention shows very high performance significantly outperforming conventional methods in all datasets. That is, since the data augmentation method according to embodiments of the invention performs transformation in a learned representation space itself, an effect of augmentation may be maximized while maintaining an intrinsic structure of data.

Method and system for data augmentation for learning of tabular data according to embodiments of the invention examined above may perform binning for table data in order to efficiently train table data.

More specifically, the control unit 150 may perform binning of assigning a bin value according to a preset criterion for various data values included in a table dataset, and may train the learning target model (for example, an encoder, an auto encoder, and the like) by using binned data obtained as a result of performing binning for the table dataset. In this case, content such as extraction of parameters of the encoder, application of a preset normalization technique (for example, dropout), performance of a preset decomposition method (for example, singular value decomposition (SVD), truncated (or reduced) singular value decomposition (SVD), and the like), encoder update, contrastive learning, and reconstruction learning has been described above in more detail, and, hereinafter, in order to avoid duplication of description, description will be provided only briefly.

For example, table data may be structured in a table form including row information indicating information of various heterogeneous features of an individual sample and column information indicating information for a feature of a plurality of samples.

Table data may have categorical features which are difficult to be represented as a number such as gender, country and the like and may be represented as a character, a noun, or a combination of specific words and the like, and numerical features which may be represented as a number such as height, weight, age and the like, together. As a result of this, table data may have heterogeneous features.

In order for an artificial intelligence model to efficiently train features of table data, there is a necessity to sufficiently handle heterogeneous features of such table data. To this end, in embodiments of the invention, by performing binning for table data to generate binned data, and training the learning target model based on table data and binned data, an artificial intelligence model 160 capable of effectively extracting features in which heterogeneous features of table data are appropriately reflected may be constructed.

Here, binned data may mean a specific numerical value assigned to data included in table data. For example, binned data may be data corresponding to a representative value assigned to numerical data corresponding to a predetermined range or a specific numerical value assigned to categorical data, and may be data corresponding to a bin value. As such, binned data generated by performing binning for table data may be data to which inductive bias is applied in table data.

Hereinafter, binning for table data according to one of the embodiments of the invention is performed, and a method for training a learning target model on the basis thereof is examined more specifically.

As illustrated in FIG. 12A and FIG. 12C, the control unit 150 may obtain table data 1200.

The control unit 150 may receive (or obtain) table data 1200 by inputting from a user terminal 10 or from an outside. For example, the control unit 150 may directly receive table data 1200 from an outside, or may extract table data 1200 from document data received from an outside (for example, a paper, a book, a patent document, a report, and the like). The control unit 150 may extract table data structured in a table form, from input document data based on a machine learning model and/or a document understanding model included in the data augmentation system 100.

As an example, table data may relate to personal information such as age, height, weight, and gender of multiple persons, and may include information in which various feature information for a plurality of samples is structured in a table form. Here, a plurality of samples may correspond to multiple persons.

Alternatively, table data may include various types of information related to various industrial fields. In this case, table data may include numerical information which may be represented as a continuous numerical value, and categorical information which is difficult to be represented as a numerical value and may be represented as a character, a noun, or a combination of specific words.

As an example, table data may be information related to products held by a store, and may include numerical information such as a product year, a weight, a length, and the like and categorical information such as a brand name, a color, and the like of the product.

As another example, table data may be information related to an item produced in a manufacturing factory, and may include numerical information such as a height, a width, a breadth, and the like of a produced item and categorical information such as manufacturing process line information of the produced item, manufacturing process management supervisor information, and the like.

As described above, table data may include at least one among numerical information and categorical information, and may be data of information in which various types of information related to a plurality of samples is structured in a table form. In addition, table data may include information about various types of samples related to various industrial fields.

Such table data may show heterogeneous features by simultaneously including numerical information and categorical information. In addition, since information about a plurality of samples included in table data may have irregular values regardless of a specific pattern, table data may have Irregularities.

The control unit 150 may perform binning for the table data 1200, thereby obtaining a plurality of binned table data 1201, 1202, and 1203. In embodiments of the invention, a plurality of binned table data may also be named as “a plurality of binned data” or “a plurality of binning data” or “a plurality of binned table data” or “a plurality of binned dataset” and the like.

More specifically, the control unit 150 may perform binning for the table data 1200 by using a binning module 500, and may obtain a plurality of binned table data 1201, 1202, and 1203 output (or generated) from the binning module 500. In this case, the binning module 500 may be a configuration included in the learning target model. Alternatively, the binning module 500 may be configured as a configuration separate from the learning target model (for example, being included in the data augmentation system 100). The embodiments of the invention is not limited to any one thereof.

Binning may mean assigning one representative value to information included in a predetermined (or at least a part of) numerical range among various information included in the table data. Here, a representative value may be referred to as a bin value. In this case, binned table data may mean data about a plurality of bin values generated by performing binning for table data. A bin value, which is a representative value for assigning to various information included in table data, may also be irregularly set.

The binning module 500 may be a module (or a model, an encoder, an auto encoder, and the like) trained to, when the table data 1200 is input, perform binning for the table data 1200 and output a plurality of binned table data 1201, 1202, and 1203 generated. The binning module 500 may be a module trained to effectively extract a feature including irregularity of table data. As a result of performing binning through the binning module 500, the table data 1200 may be divided into a plurality of sub-table data. In the embodiments of the invention, this may be named as binned table data 1201, 1202, and 1203. Further, the plurality of sub-table data may also be named as a plurality of table data. As a result of performing binning through the binning module 500, a plurality of binned table data 1201, 1202, and 1203 may be obtained.

Also, the binning module 500 may perform binning for the table data 1200, thereby grouping data samples having similar values. Through this, the binning module 500 may extract a data feature robust to an error which may occur according to analysis of individual data which is not grouped.

That is, the binning module 500 may be configured to perform a role of effectively extracting a feature of the table data 1200 based on binning for the table data 1200.

In one embodiment, the binning module 500 may assign different bin values to a plurality of different categorical data for a plurality of samples included in the table data 1200. In this case, since a plurality of bin values are assigned to a plurality of different categorical data included in table data 1200, the plurality of categorical data may be converted to numerical data.

In another embodiment, the table data 1200 may include a plurality of column information which is raw feature values related to a feature for a plurality of samples, and the binning module 500 may convert the raw feature values of such table data into a plurality of binned table data 1201, 1202, and 1203. The raw feature values in a form of column information included in table data may be converted into a plurality of binned table data 1201, 1202, and 1203, and, in this case, the raw feature values may be respectively included in a plurality of sections divided arbitrarily, and, for each of the raw feature values, a bin value which is a representative value corresponding to the section may be assigned.

Further, a number of a plurality of bin values assigned to a plurality of numerical data included in table data 1200 may be variously set. For example, the number of a plurality of bin values may be 2 to 100. However, the number of a plurality of bin values is not necessarily limited thereto, and the number of a plurality of bin values may be set to be less than 2 or set to be greater than 100.

As such, among a plurality of numerical data for a plurality of samples included in table data, the same one bin value may be assigned to some numerical data within a predetermined range. In addition, different bin values may be assigned to each of a plurality of different categorical data for a plurality of samples included in table data. A plurality of bin values assigned to a plurality of samples may also be understood as binned table data.

Accordingly, the control unit 150 may obtain, from the binning module 500, binned table data in which a plurality of numerical data included in table data is replaced with a bin value of a corresponding range, or binned table data in which a plurality of categorical data is replaced with a bin value in a numerical form.

Since such binned table data is data generated by replacing numerical data or categorical data included in existing table data with a bin value instead of an original value, binned data may be data to which inductive bias is applied to table data.

As illustrated in FIG. 12A and FIG. 12C, the control unit 150 may input a plurality of binned table data 1201, 1202, and 1203 corresponding to the table data 1200 obtained from the binning module 500 to the first encoder 161, respectively. Further, the control unit 150 may obtain embedding vectors 1201a, 1202a, and 1203a corresponding to each of a plurality of binned table data 1201, 1202, and 1203 generated (or output) from the first encoder 161.

The first encoder 161 may be trained to, when a plurality of binned table data 1201, 1202, and 1203 is respectively input, generate embedding vectors 1201a, 1202a, and 1203a corresponding to each of the plurality of binned table data 1201, 1202, and 1203. In this case, as the plurality of binned table data 1201, 1202, and 1203 is input to the first encoder 161, a plurality of embedding vectors corresponding to the plurality of binned table data 1201, 1202, and 1203 may be generated from the first encoder 161.

For example, the first encoder 161 may generate a first embedding vector 1201a corresponding to the first binned table data 1201. The control unit 150 may obtain, from the first encoder 161, the first embedding vector 1201a generated for the first binned table data 1201.

As another example, the first encoder 161 may generate a second embedding vector 1202a corresponding to the second binned table data 1202. The control unit 150 may obtain, from the first encoder 161, the second embedding vector 1202a generated for the second binned table data 1202.

As still another example, the first encoder 161 may generate a third embedding vector 1203a corresponding to the third binned table data 1203. The control unit 150 may obtain, from the first encoder 161, the third embedding vector 1203a generated for the third binned table data 1203.

Further, the control unit 150 may extract a specific parameter 161a of the first encoder 161 based on a preset extraction criterion. Based on a preset extraction criterion, the control unit 150 may extract the specific parameter 161a among a plurality of parameters included in the first encoder 161 trained to generate a plurality of embedding vectors 1201a, 1202a, and 1203a corresponding to each of a plurality of binned table data 1201, 1202, and 1203. The control unit 150, according to the preset extraction criterion, may extract the specific parameter 161a from the final layer among layers of the first encoder 161.

Subsequently, the control unit 150 may input the extracted the specific parameter 161a to the specific module 400. As examined above, the specific module 400 may be configured to perform a role of, after performing singular value decomposition for the specific parameter 161a by using a preset decomposition method, generating (or outputting) a new parameter to be used for update of the second encoder 162.

For example, in order to preserve important information (or core information) of a plurality of binned table data 1201, 1202, and 1203 for the table data 1200, the specific module 400 may perform singular value decomposition for the specific parameter 161a of a final layer of the first encoder 161, and then approximate to a low-dimensional parameter preserving only a singular value satisfying a preset criterion and a first singular vector and a second singular vector corresponding to the singular value.

The control unit 150 may update the second encoder 162 by using an output of the specific module 400 for the specific parameter 161a. A parameter 162a corresponding to an output from the specific module 400 may be used for updating the second encoder 162. The control unit 150 may update the second encoder 162 by using the parameter 162a obtained from the specific module 400.

Further, as illustrated in FIG. 12A and FIG. 12C, the control unit 150 may respectively input a plurality of binned table data 1201, 1202, and 1203 to the updated second encoder 162, and may obtain, from the updated second encoder 162, augmented embedding vectors 1201b, 1202b, and 1203b corresponding to each of the plurality of binned table data 1201, 1202, and 1203.

An update process of the second encoder 162 examined above may be a process of updating the second encoder 162 by using an output of the specific module 400 in order to generate augmented new embedding vectors for each of a plurality of embedding vectors 1201a, 1202a, and 1203a obtained from the first encoder 161 (or for each of the plurality of embedding vectors 1201a, 1202a, and 1203a, from each of the plurality of embedding vectors 1201a, 1202a, and 1203a, and the like). Alternatively, the update process may be a process of updating the second encoder 162 by using an output of the specific module 400 in order to generate a positive representation (or a positive view, or a positive sample, a positive modification (or transformation), and the like) for each of a plurality of embedding vectors 1201a, 1202a, and 1203a obtained from the first encoder 161.

Such an updated second encoder 162 may be configured to generate augmented embedding vectors 1201b, 1202b, and 1203b corresponding to each of the plurality of binned table data 1201, 1202, and 1203 based on the set parameter 162a. In this case, as a plurality of binned table data 1201, 1202, and 1203 is input to the second encoder 162, a plurality of augmented embedding vectors 1201b, 1202b, and 1203b corresponding to the plurality of binned table data 1201, 1202, and 1203 may be generated from the second encoder 162.

For example, the second encoder 162 may generate a first embedding vector 1201b corresponding to the first binned table data 1201. The control unit 150 may obtain, from the second encoder 162, an augmented first embedding vector 1201b generated for the first binned table data 1201.

As another example, the second encoder 162 may generate a second embedding vector 1202b corresponding to the second binned table data 1202. The control unit 150 may obtain, from the second encoder 162, the second embedding vector 1202b generated for the second binned table data 1202.

As still another example, the second encoder 162 may generate a third embedding vector 1203b corresponding to the third binned table data 1203. The control unit 150 may obtain, from the second encoder 162, the third embedding vector 1203b generated for the third binned table data 1203.

The control unit 150 may train a learning target model by using a plurality of embedding vectors 1201a, 1202a, and 1203a obtained from the first encoder 161 and a plurality of augmented embedding vectors 1201b, 1202b, and 1203b obtained from the second encoder 162.

As illustrated in FIG. 12A and FIG. 12C, the control unit 150 may generate a combined embedding vector by combining embedding vectors corresponding to each of a plurality of binned table data 1201, 1202, and 1203.

The control unit 150 may combine a plurality of embedding vectors 1201a, 1202a, and 1203a corresponding to each of a plurality of binned table data 1201, 1202, and 1203 obtained from the first encoder 161 by using a combining module 600. Also, the control unit 150 may combine a plurality of augmented embedding vectors 1201b, 1202b, and 1203b corresponding to each of a plurality of binned table data 1201, 1202, and 1203 obtained from the second encoder 162 by using the combining module 600.

For example, the combining module 600 may combine a plurality of embedding vectors (a first embedding vector 1201a, a second embedding vector 1202a, and a third embedding vector 1203a, and the like) corresponding to a plurality of binned table data 1201, 1202, and 1203 obtained from the first encoder 161, thereby generating a combined first embedding vector 1211 corresponding to the table data 1200.

As another example, the combining module 600 may combine a plurality of augmented embedding vectors (a first embedding vector 1201b, a second embedding vector 1202b, and a third embedding vector 1203b) corresponding to a plurality of binned table data 1201, 1202, and 1203 obtained from the second encoder 162, thereby generating a combined second embedding vector 1212 corresponding to the table data 1200.

The control unit 150 may train the learning target model by using the combined first embedding vector 1211 and the combined second embedding vector 1212. A method of training the learning target model is the same as the content described in detail above, and thus, it will be briefly described only in order to avoid redundancy of description.

First, as illustrated in FIG. 12A and FIG. 12C, the control unit 150 may respectively input the combined first embedding vector 1211 and the combined second embedding vector 1212 to the projection head 163. In this case, the control unit 150 may configure the combined first embedding vector 1211 and the combined second embedding vector 1212 as one positive pair (or a pair), and may train the learning target model by using a positive pair including (or in which the combined first embedding vector 1211 and the combined second embedding vector 1212 form a pair) the combined first embedding vector 1211 and the combined second embedding vector 1212.

The control unit 150 may respectively obtain, from the projection head 163, a first projection vector 1211a corresponding to the combined first embedding vector 1211 and a second projection vector 1212a corresponding to the combined second embedding vector 1212. Further, the control unit 150 may define a first loss function for contrastive learning by using the first projection vector 1211a and the second projection vector 1212a.

The first loss function may be defined to learn similarity between the combined first embedding vector 1211 and the combined second embedding vector 1212. The control unit 150 may train at least one among the first encoder 161 and the projection head 163 by using the first loss function. For example, the control unit 150 may calculate a contrastive loss based on similarity between the first projection vector 1211a and the second projection vector 1212a by using the first loss function, and may update a parameter of at least one among the first encoder 161 and the projection head 163 based on the calculated contrastive loss.

Next, the control unit 150 may input the combined first embedding vector 1211. The decoder 164 may reconstruct the combined first embedding vector 1211 so as to correspond to the original table data 1200, thereby generating a reconstructed output value 1221.

The control unit 150 may obtain the reconstructed output value 1221 from the decoder 164, and may define a second loss function for reconstruction learning by using the reconstructed output value 1221 and the table data 1200.

The second loss function may be defined to learn a relationship between the table data 1200 and the reconstructed output value 1221. By using the second loss function, the control unit 150 may train at least one among the first encoder 161 and the decoder 164. For example, the control unit 150 may calculate a reconstruction loss between the table data 1200 and the reconstructed output value 1221 by using the second loss function, and may update a parameter of at least one among the first encoder 161 and the decoder 164 based on the calculated reconstruction loss.

Further, the control unit 150 may define a final loss function (or an overall loss function) by using the first loss function and the second loss function, and may train the learning target model by using the final loss function. In this case, a process of training the learning target model by using the final loss function may also be understood as a process of updating a parameter of at least one among the first encoder 161, the projection head 163, and the decoder 164 such that a difference between a first loss value and a second loss value calculated by calculating the first loss function and the second loss function included in the final loss function, respectively, is minimized.

In a process examined above, it has been described that embedding vectors corresponding to binned table data are combined through the combining module 600, and that the combined embedding vector is input to each of the projection head 163 and the decoder 164, however, the inventive concepts are not necessarily limited thereto.

In one embodiment, as illustrated in FIG. 12B, the control unit 150 may respectively input embedding vectors 1201a, 1202a, and 1203a corresponding to a plurality of binned table data 1201, 1202, and 1203 obtained from the first encoder 161 to the projection head 163. In this case, a first embedding vector 1201a corresponding to the first binned table data 1201 is input to the projection head 163, and a first projection vector 1211a corresponding to the first embedding vector 1201a may be obtained from the projection head 163. Also, a second embedding vector 1202a corresponding to the second binned table data 1202 is input to the projection head 163, and a second projection vector (not illustrated) corresponding to the second embedding vector 1202a may be obtained from the projection head 163. Also, a third embedding vector 1203a corresponding to the third binned table data 1203 is input to the projection head 163, and a third projection vector (not illustrated) corresponding to the third embedding vector 1203a may be obtained from the projection head 163.

In another embodiment, the control unit 150 may respectively input augmented embedding vectors 1201b, 1202b, and 1203b corresponding to a plurality of binned table data 1201, 1202, and 1203 obtained from the updated second encoder 161 to the projection head 163. In this case, an augmented first embedding vector 1201b corresponding to the first binned table data 1201 is input to the projection head 163, and a first projection vector 1211a corresponding to the first embedding vector 1201b may be obtained from the projection head 163. Also, an augmented second embedding vector 1202b corresponding to the second binned table data 1202 is input to the projection head 163, and a second projection vector (not illustrated) corresponding to the second embedding vector 1202b may be obtained from the projection head 163. In addition, an augmented third embedding vector 1203b corresponding to the third binned table data 1203 is input to the projection head 163, and a third projection vector (not illustrated) corresponding to the third embedding vector 1203b may be obtained from the projection head 163.

In this case, in a contrastive learning process, the control unit 150 may define the first loss function by using the first projection vector 1211a for the first embedding vector 1201a corresponding to the first binned table data 1201 and the first projection vector 1211a for the augmented first embedding vector 1201b corresponding to the first binned table data 1201, and may train at least one among the first encoder 161 and the projection head 163 by using the first loss function. Also, in the contrastive learning process, the control unit 150 may define the first loss function by using a second projection vector for the second embedding vector 1202a corresponding to the second binned table data 1202 and a second projection vector for the augmented second embedding vector 1202b corresponding to the second binned table data 1202, and may train at least one among the first encoder 161 and the projection head 163 by using the first loss function.

Further, in the contrastive learning process, the control unit 150 may define the first loss function by using a third projection vector for the third embedding vector 1203a corresponding to the third binned table data 1203 and a third projection vector for the augmented third embedding vector 1203b corresponding to the third binned table data 1203, and may train at least one among the first encoder 161 and the projection head 163 by using the first loss function.

In another embodiment, the control unit 150 may input a plurality of embedding vectors (a first embedding vector 1201a, a second embedding vector 1202a, and a third embedding vector 1203a, and the like) corresponding to a plurality of binned table data 1201, 1202, and 1203 obtained from the first encoder 161 to the decoder 164. The decoder 164 may reconstruct a plurality of embedding vectors 1201a, 1202a, and 1203a to correspond to the original table data 1200, thereby generating a reconstructed output value 1221.

The control unit 150 may obtain the reconstructed output value 1221 from the decoder 164, and after defining the second loss function for reconstruction learning by using the reconstructed output value 1221 and the table data 1200, may train at least one among the encoder 161 and the decoder 164 by using the second loss function.

As described above, according to a method of performing binning for table data and training the learning target model based thereon according to one embodiment of the invention, by performing binning for table data, an appropriate inductive bias may be imparted to table data so that an artificial intelligence model may effectively learn an irregular function. In embodiments of the invention, by training the binning module to output binned data by performing binning for table-form data, the binning module may be configured to effectively extract a feature including irregularities of table data. That is, in embodiments of the invention, by combining the binning module trained to effectively extract a feature of a table dataset with various types of downstream task models, an artificial intelligence model capable of effectively performing various types of tasks based on a table-form dataset may be provided.

As described above, according to a method and a system for data augmentation for learning of tabular data according to embodiments of the invention, by combining a preset normalization technique and a preset decomposition method, it is possible to generate a variety of augmented representations while preserving an important feature of table data in an embedding space. Through this, in embodiments of the invention, it is possible to maintain important information to increase quality of an augmented representation, and to promote robust feature learning of a model through variability.

Also, according to the method and the system for data augmentation for learning of tabular data according to embodiments of the invention, it is possible to update an encoder based on a parameter of the encoder extracted according to a preset extraction criterion, and to generate an augmented representation corresponding to table data by using the updated encoder. Through this, in embodiments of the invention, it is possible to secure diversity of an augmented representation while maintaining core information of table data. That is, in embodiments of the invention, it is possible to generate a new augmented representation while maintaining a structure of table data by using the updated encoder.

Further, according to the method and the system for data augmentation for learning of tabular data according to embodiments of the invention, it is possible to increase diversity of a representation space by applying a preset normalization technique to the encoder. That is, embodiments of the invention may induce generation of various modifications by randomly removing a part of a parameter of the encoder to which the preset normalization technique is applied. Through this, in embodiments of the invention, it is possible to allow the model to learn a generalized representation, and to prevent overfitting to a specific pattern. That is, embodiments of the invention allow the model to learn a more robust representation by applying the preset normalization technique to the encoder, and allow experience of various data modifications.

As described above, according to a method and system for data augmentation for learning of tabular data according to embodiments of the invention, by performing transformation in a learned embedding space itself by using the preset normalization technique and a preset decomposition method, an effect of augmentation may be maximized while maintaining an essential structure of table data. Through this, more robust representation learning is possible also in table data, and learning of the model may be stably performed. That is, the embodiments of the invention may improve learning performance of the model by maintaining important information while minimizing information loss.

The inventive concepts described above may be implemented based on a quantum computer. The inventive concepts implemented based on a quantum computer may include a quantum processor and quantum memory based on qubits, and may include a software and hardware interface optimized for quantum operations.

The quantum processor of the quantum computer may efficiently process complex operations through parallel computation, quantum entanglement, quantum superposition, etc. using qubits, which cannot be performed by binary bits in the classical computer. The quantum processor may process data using a quantum gate and may provide exponential speed improvements for specific problems.

The inventive concepts described above may be executed by one or more processes on a computer and implemented as a program that may be stored on a non-transitory computer-readable medium (or recording medium).

Further, the inventive concepts described above may be implemented as computer-readable code or instructions on a non-transitory medium in which a program is recorded. That is, the embodiments of the invention may be provided in the form of a program.

The non-transitory computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, optical data storage devices, and the like.

Further, the non-transitory computer-readable medium may be a server or cloud storage that includes storage (or repository) and that the electronic device is accessible through communication. In this case, the computer may download the program according to the embodiments of the invention from the server or cloud storage, through wired or wireless communication.

A computer program may reach the system 100 through various suitable delivery mechanisms. The delivery mechanism may be, for example, a non-transitory computer-readable storage medium, a computer program product, a memory device, a recording medium such as a CD-ROM or DVD, or a product that tangibly implements a computer program. The delivery mechanism may be a signal configured to reliably transmit a computer program through air or an electrical connection. The system 100 may propagate or transmit the computer program as a computer data signal.

Further, references to "non-transitory computer-readable storage medium", "computer program product", "tangibly embodied computer program", etc. or "control unit", "computer", "processor", etc., should be understood to also include computers having various architectures, such as single/multi-processor architecture, and sequential (Von Neumann)/parallel architecture, as well as specialized circuits such as field-programmable gate array (FPGA), application-specific integrated circuit (ASIC), signal processing devices, and other devices. References to a computer program, instructions, codes, etc., should be understood to include software for programmable processors or firmware, such as programmable content of a hardware device, whether it is instructions for a processor, or configuration settings for a fixed-function device, a gate array, or a programmable logic device.

Further, in embodiments of the invention, the computer described above is an electronic device equipped with a processor, that is, a central processing unit (CPU), and is not particularly limited to any type.

The method and system for data augmentation for learning of tabular data according to embodiments of the invention are capable of effectively identifying and maintaining an important pattern and a relationship in tabular data.

More specifically, the method and the system for data augmentation for learning of tabular data according to embodiments of the invention are capable of generating a variety of augmented representations while maintaining important information of tabular data.

Further, the method and system for data augmentation for learning of tabular data according to embodiments of the invention are capable of maximizing an effect of self-supervised learning (SSL) in tabular data.

As described above, according to a method and a system for data augmentation for learning of tabular data according to embodiments of the invention, by combining a preset normalization technique and a preset decomposition method, it is possible to generate a variety of augmented representations while preserving an important feature of table data in an embedding space. Through this, in the embodiments of the invention, it is possible to maintain important information to increase quality of an augmented representation, and to promote robust feature learning of a model through variability.

Also, according to the method and the system for data augmentation for learning of tabular data according to the embodiments of the invention, it is possible to update an encoder based on a parameter of the encoder extracted according to a preset extraction criterion, and to generate an augmented representation corresponding to table data by using the updated encoder. Through this, in the embodiments of the invention, it is possible to secure diversity of an augmented representation while maintaining core information of table data. That is, in the embodiments of the invention, it is possible to generate a new augmented representation while maintaining a structure of table data by using the updated encoder.

Further, according to the method and the system for data augmentation for learning of tabular data according to the embodiments of the invention, it is possible to increase diversity of a representation space by applying a preset normalization technique to the encoder. That is, the embodiments of the invention may induce generation of various modifications by randomly removing a part of a parameter of the encoder to which the preset normalization technique is applied. Through this, in the embodiments of the invention, it is possible to allow the model to learn a generalized representation, and to prevent overfitting to a specific pattern. That is, the embodiments of the invention allow the model to learn a more robust representation by applying the preset normalization technique to the encoder, and allows experience of various data modifications.

As described above, according to the method and the system for data augmentation for learning of tabular data according to the embodiments of the invention, by performing augmentation and modification in a learned embedding space (that is, a structured representation space) itself using the preset normalization technique and the preset decomposition method, it is possible to maximize an effect of augmentation while maintaining an essential structure of table data. Through this, more robust representation learning is possible also in table data, and learning of the model may be stably performed. That is, the embodiments of the invention may improve learning performance of the model by maintaining important information while minimizing information loss.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A data augmentation method for learning of tabular data, in a computerized method, comprising:
inputting table data to at least one first encoder;
obtaining, as an output of the first encoder, a first embedding vector corresponding to the table data;
extracting, based on a preset extraction criterion, a specific parameter from the first encoder from which the first embedding vector is output;
updating, based on the specific parameter extracted according to the preset extraction criterion, a parameter of at least one second encoder distinguished from the first encoder;
inputting the table data to the updated the second encoder;
obtaining, from the second encoder, an augmented second embedding vector corresponding to the table data; and
training a learning target model by using the first embedding vector and the second embedding vector.

2. The data augmentation method of claim 1, further comprising:
inputting the specific parameter extracted from the first encoder to a preset specific module; and
performing, in the specific module, decomposition of the specific parameter by using a preset decomposition method.

3. The data augmentation method of claim 2, wherein:
the specific module decomposes the specific parameter into at least one among a first singular vector matrix including a first singular vector, a second singular vector matrix including a second singular vector, and a diagonal matrix including a singular value corresponding to the first singular vector and the second singular vector, respectively; and
the updating of the second encoder comprises updating the second encoder by using an output of the specific module for the specific parameter.

4. The data augmentation method of claim 3, further comprising:
specifying at least one singular value satisfying a preset criterion among the singular values; and
generating, based on the specified singular value, a parameter to be used for updating the second encoder,
wherein the parameter corresponds to the output of the specific module for the specific parameter, and the parameter is used for updating the second encoder.

5. The data augmentation method of claim 4, wherein the specific module:
specifies a singular value specified according to the preset criterion among the singular values;
specifies at least one among a first singular vector and a second singular vector corresponding to the specified singular value; and
generates the parameter based on at least one among the specified singular value, the specified first singular vector, and the specified second singular vector.

6. The data augmentation method of claim 4, wherein the updating of the other encoder comprises updating the second encoder by using the parameter output from the specific module.

7. The data augmentation method of claim 6, wherein:
the updating of the second encoder comprises:
inputting the parameter to the second encoder; and
setting the parameter of the second encoder to the parameter output from the specific module; and
the updated second encoder is configured to generate the augmented second embedding vector corresponding to the table data based on the set parameter.

8. The data augmentation method of claim 4, wherein the updating of the second encoder comprises updating the second encoder by using the output of the specific module to generate the augmented second embedding vector for the first embedding vector obtained from the first encoder.

9. The data augmentation method of claim 1, further comprising applying a preset normalization technique to at least one among the first encoder and the second encoder.

10. The data augmentation method of claim 9, wherein, when the preset normalization technique is applied to at least one among the first encoder and the second encoder, stochastic variability is imparted to at least one among the first embedding vector corresponding to the table data obtained from the first encoder and the second embedding vector corresponding to the table data obtained from the second encoder.

11. The data augmentation method of claim 1, further comprising, for training of the learning target model, defining a first loss function and a second loss function, respectively, by using at least one among the first embedding vector and the second embedding vector.

12. The data augmentation method of claim 11, further comprising:
inputting the first embedding vector and the second embedding vector to a projection head, respectively; and
obtaining, from the projection head, a first projection vector corresponding to the first embedding vector and a second projection vector corresponding to the second embedding vector,
wherein the first loss function is defined by using the first projection vector corresponding to the first embedding vector and the second projection vector corresponding to the second embedding vector.

13. The data augmentation method of claim 12, wherein the first loss function is defined to be trained in a direction of maximizing similarity between the first embedding vector and the second embedding vector.

14. The data augmentation method of claim 11, further comprising:
inputting the first embedding vector to at least one decoder; and
obtaining, from the at least one decoder, a reconstructed output value by reconstructing the first embedding vector to correspond to the table data,
wherein the second loss function is defined by using the table data and the reconstructed output value.

15. The data augmentation method of claim 14, wherein the second loss function is defined to learn a relationship between the table data and the reconstructed output value.

16. The data augmentation method of claim 11, further comprising defining a final loss function by using the first loss function and the second loss function,
wherein the learning target artificial intelligence model is trained by using the final loss function.

17. The data augmentation method of claim 1, further comprising:
performing binning for the table data;
obtaining, as a result of performing the binning for the table data, a plurality of binned table data; and
training the learning target model by using the plurality of binned table data.

18. A data augmentation method for learning of tabular data, in a computerized method, comprising:
performing binning for table data;
obtaining, as a result of performing the binning for the table data, a plurality of binned table data;
inputting the plurality of binned table data to at least one first encoder;
obtaining, as an output of the first encoder, a plurality of embedding vectors corresponding to the plurality of binned table data, respectively;
extracting, based on a preset extraction criterion, a specific parameter from the first encoder from which the plurality of embedding vectors is output;
updating, based on the specific parameter extracted according to the preset extraction criterion, at least one second encoder;
inputting the plurality of binned table data to the updated second encoder;
obtaining, from the second encoder, a plurality of augmented embedding vectors corresponding to the plurality of binned table data, respectively; and
training a learning target model by using the plurality of embedding vectors obtained from the first encoder and the plurality of augmented embedding vectors obtained from the second encoder.

19. A data augmentation system for learning of tabular data, the data augmentation system comprising:
a memory configured to store executable instructions; and
one or more processors configured to perform operations by executing one or more instructions,
wherein the data augmentation system is configured to:
input table data to at least one first encoder;
obtain, as an output of the first encoder, a first embedding vector corresponding to the table data;
extract, based on a preset extraction criterion, a specific parameter from the first encoder from which the first embedding vector is output;
update, based on the specific parameter extracted according to the preset extraction criterion, a parameter of at least one second encoder distinguished from the first encoder;
input the table data to the updated second encoder;
obtain, from the second encoder, an augmented second embedding vector corresponding to the table data; and
train a learning target model by using the first embedding vector and the second embedding vector.
